(19) United States
(12) Patent Application Publication
(10) Pub. No.: US 2010/0259521 A1
(43) Pub. Date: Oct. 14, 2010

(54) DRIVING DEVICE AND DRIVING METHOD OF PLASMA DISPLAY PANEL AND PLASMA DISPLAY APPARATUS

(75) Inventors: Toshiyuki Maeda, Hyogo (JP); Kenji Ogawa, Osaka (JP); Naoki Noguchi, Osaka (JP); Takahiko Origuchi, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/747,003

(22) PCT Filed: Sep. 4, 2008
(86) PCT No.: PCT/JP2008/002436

§ 371 Date: Jun. 9, 2010

(30) Foreign Application Priority Data
Dec. 26, 2007 (JP) 2007-334195

(51) Int. Cl. G09G 3/28; G09G 5/00

(52) U.S. Cl. 345/207; 345/208; 345/60

(57) ABSTRACT

A two-phase driving operation is performed by a first circuit and a second circuit in at least one sub-field. The first circuit applies a first ramp waveform that drops from a first potential to a second potential to a plurality of first scan electrodes in a setup period, and sequentially applies a scan pulse to the plurality of first scan electrodes in a write period. The second circuit applies a second ramp waveform that drops from the first potential to a third potential that is higher than the second potential to a plurality of second scan electrodes, and then raises the plurality of second scan electrodes to a fourth potential in the setup period, and holds the plurality of second scan electrodes at a fifth potential that is higher than the third potential and lower than the fourth potential in a period where the first scan pulse is applied, and then sequentially applies a scan pulse to the plurality of second electrodes in the write period. Discharge failures during write discharges can be prevented from occurring by employing the two-phase driving operation.

### TECHNICAL FIELD

The present invention relates to a driving device and a driving method of a plasma display panel and a plasma display apparatus employing the same.

### BACKGROUND ART

An AC surface discharge type panel that is typical as a plasma display panel (hereinafter abbreviated as a “panel”) includes a number of discharge cells between a front plate and a back plate arranged to face each other.

The front plate is constituted by a front glass substrate, a plurality of display electrodes, a dielectric layer and a protective layer. Each display electrode is composed of a pair of scan electrode and sustain electrode. The plurality of display electrodes are formed in parallel with one another on the front glass substrate, and the dielectric layer and the protective layer are formed to cover the display electrodes.

The back plate is constituted by a back glass substrate, a plurality of data electrodes, a dielectric layer, a plurality of barrier ribs and phosphor layers. The plurality of data electrodes are formed in parallel with one another on the back glass substrate, and the dielectric layer is formed to cover the data electrodes. The plurality of barrier ribs are formed in parallel with the data electrodes, respectively, on the dielectric layer, and the phosphor layers of R (red), G (green) and B (blue) are formed on a surface of the dielectric layer and side surfaces of the barrier ribs.

The front plate and the back plate are arranged to face each other such that the display electrodes intersect with the data electrodes in three dimensions, and then sealed. An inside discharge space is filled with a discharge gas. The discharge cells are formed at respective portions at which the display electrodes and the data electrodes face one another.

In the panel having such a configuration, a gas discharge generates ultraviolet rays, which cause phosphors of R, G and B to be excited and to emit light in each of the discharge cells. Accordingly, color display is performed.

A sub-field method is employed as a method of driving the panel (see Patent Document 1, for example). In the sub-field method, one field period is divided into a plurality of sub-fields, and the discharge cells are caused to emit light or not in the respective sub-fields, so that gray scale display is performed. Each of the sub-fields has a setup period, a write period and a sustain period.

In the setup period, a setup pulse is applied to each scan electrode, and a setup discharge is performed in each discharge cell. Thus, wall charges required for a subsequent write operation are formed in each discharge cell.

In the write period, a scan pulse is sequentially applied to the scan electrodes while a write pulse corresponding to an image signal to be displayed is applied to the data electrodes. This selectively generates write discharges between the scan electrodes and the data electrodes, causing the wall charges to be selectively formed.

In the subsequent sustain period, a sustain pulse is applied between the scan electrodes and the sustain electrodes a given number of times corresponding to luminances to be displayed. Accordingly, discharges are selectively induced in the discharge cells in which the wall charges have been formed by the write discharges, causing the discharge cells to emit light.

The plurality of scan electrodes are driven by a scan electrode drive circuit, the plurality of sustain electrodes are driven by a sustain electrode drive circuit and the plurality of data electrodes are driven by a data electrode drive circuit.

[Patent Document 1] JP 2006-18298 A

### DISCLOSURE OF THE INVENTION

### [Problems to be Solved by the Invention]

As described above, the scan pulse is sequentially applied to the plurality of scan electrodes in the write period. Therefore, it takes a longer time period from application of the setup pulse to application of the scan pulse in a discharge cell, which is subjected to the application of the scan pulse relatively late, of the plurality of discharge cells.

Here, the wall charges formed in the discharge cell by the setup discharge is gradually decreased under influence of the write pulse applied to the data electrodes for generating the write discharges in other discharge cells. Therefore, in the discharge cell subjected to the application of the scan pulse relatively late, the wall charges are decreased by the time of the application of the scan pulse and the write pulse. This leads to an occurrence of a discharge failure during the write discharge.

An object of the present invention is to provide a driving device and a driving method of a plasma display panel in which a discharge failure during a write discharge can be prevented from occurring, and a plasma display apparatus employing the same.

### [Means for Solving the Problems]

(1) According to an aspect of the present invention, a driving device of a plasma display panel that drives the plasma display panel including discharge cells at intersections of a plurality of first and second scan electrodes and a plurality of sustain electrodes with a plurality of data electrodes by a sub-field method in which one field period includes a plurality of sub-fields includes a first circuit that drives the plurality of first scan electrodes, and a second circuit that drives the plurality of second scan electrodes, wherein the first and second circuits perform a two-phase driving operation in at least one sub-field of the plurality of sub-fields, the first circuit applies a first ramp waveform that drops from a first potential to a second potential to the plurality of first scan electrodes in a setup period, and sequentially applies a scan pulse to the plurality of first scan electrodes in a write period in the two-phase driving operation, and the second circuit applies a second ramp waveform that drops from the first potential to a third potential that is higher than the second potential to the plurality of second scan electrodes and raises a potential of the plurality of second scan electrodes to a fourth potential after the second ramp waveform is applied in the setup period, and holds the plurality of second scan electrodes at a fifth potential that is higher than the third potential and lower than the fourth potential and sequentially applies a scan pulse to the plurality of second scan electrodes after the scan pulse is applied to the plurality of first scan electrodes in the write period in the two-phase driving operation.

In the driving device, the two-phase driving operation is performed by the first and second circuits in the at least one sub-field of the plurality of sub-fields.

In the two-phase driving operation, the first ramp waveform that drops from the first potential to the second potential is applied to the plurality of first scan electrodes by the first circuit in the setup period. This generates weak discharges in discharge cells on the first scan electrodes, decreasing an amount of wall charges in the discharge cells. As a result, the amount of the wall charges in the discharge cells on the first scan electrodes is made suitable for a write operation.

The second ramp waveform that drops from the first potential to the third potential is applied to the plurality of second scan electrodes by the second circuit in the setup period. This generates weak discharges in discharge cells on the second scan electrodes, decreasing an amount of wall charges in the discharge cells. The potential of the second scan electrodes is subsequently raised to the fourth potential by the second circuit, so that the discharges are stopped in the discharge cells on the second scan electrodes.

Here, the first ramp waveform drops to the second potential, whereas the second ramp waveform drops to the third potential that is higher than the second potential. Therefore, an amount of electric charges that transfer in the discharge cells on the second scan electrodes is smaller than an amount of electric charges that transfer in the discharge cells on the first scan electrodes. This causes a sufficient amount of wall charges to remain in the discharge cells on the second scan electrodes at the end of the setup period.

In the write period, the scan pulse is sequentially applied to the plurality of first scan electrodes by the first circuit. This generates write discharges in selected discharge cells on the first scan electrodes. The scan pulse is sequentially applied to the plurality of second scan electrodes by the second circuit after the scan pulse is applied to the plurality of first scan electrodes. This generates write discharges in selected discharge cells on the second scan electrodes.

As described above, the sufficient amount of electric charges remains in the discharge cells on the second scan electrodes at the end of the setup period. Therefore, the amount of the wall charges in the discharge cells on the second scan electrodes can be made suitable for the write operation at the time of the application of the scan pulse to the second scan electrodes even though the wall charges of the discharge cells on the second scan electrodes are decreased during the application of the scan pulse to the first scan electrodes. As a result, discharge failures can be prevented from occurring in the discharge cells on the second scan electrodes in the write period.

The write operation can be satisfactorily carried out in the discharge cells on the second scan electrodes even though the wall charges are decreased, thus eliminating the necessity of holding the second scan electrodes at a high potential for preventing the wall charges from decreasing in the write period. This allows reduction in driving cost and improvement of driving performance of the plasma display panel.

The discharges are suitably generated in the discharge cells on the second scan electrodes in the setup period, thereby preventing excessive electric charges from remaining in the discharge cells at the end of the setup period. This prevents erroneous discharges from occurring in the discharge cells on the second scan electrodes at the time of the application of the scan pulse to the first scan electrodes.

The second scan electrodes are held at the fifth potential that is higher than the third potential and lower than the fourth potential in the write period excluding the period where the scan pulse is applied. In this case, the electric charges in the discharge cells on the second scan electrodes are in a stable state. This more reliably prevents erroneous discharges from occurring in the discharge cells on the second scan electrodes.

(2) The second circuit may apply a third ramp waveform that drops to the plurality of second scan electrodes after the scan pulse is applied to the plurality of first scan electrodes and before the scan pulse is applied to the plurality of second scan electrodes in the write period in the two-phase driving operation.

In this case, the application of the third ramp waveform generates weak discharges in the discharge cells on the second scan electrodes. This decreases the amount of the wall charges in the discharge cells on the second scan electrodes. Therefore, the amount of the wall charges in the discharge cells on the second scan electrodes can be made suitable for the write operation even when the amount of wall charges in the discharge cells on the second scan electrodes is not sufficiently decreased at the time of the application of the scan pulse to the second scan electrodes. As a result, discharge failures can be reliably prevented from occurring in the discharge cells on the second scan electrodes in the write period.

(3) The second circuit may apply the third ramp waveform that drops from a sixth potential that is not higher than the fifth potential to a seventh potential to the plurality of second scan electrodes after the scan pulse is applied to the plurality of first scan electrodes and before the scan pulse is applied to the plurality of second scan electrodes in the write period in the two-phase driving operation.

In this case, the application of the third ramp waveform generates the weak discharges in the discharge cells on the second scan electrodes. This decreases the amount of the wall charges in the discharge cells on the second scan electrodes. Therefore, the amount of the wall charges in the discharge cells on the second scan electrodes can be made suitable for the write operation even when the amount of wall charges in the discharge cells on the second scan electrodes is not sufficiently decreased at the time of the application of the scan pulse to the second scan electrodes. As a result, discharge failures can be reliably prevented from occurring in the discharge cells on the second scan electrodes in the write period.

(4) The seventh potential may be lower than the second potential.

In this case, the amount of the electric charges remaining in the discharge cells on the first electrodes after the first ramp waveform is applied can be adjusted to be equal to the amount of the electric charges remaining in the discharge cells on the second electrodes after the third ramp waveform is applied. This prevents an occurrence of crosstalk.

(5) The driving device of the plasma display panel may further include a potential control circuit that changes a potential of a first node, and a hold circuit that holds a potential difference between the first node and a second node at a given potential difference, wherein a difference between the third potential and the fourth potential may be the given potential difference, the first circuit may include a plurality of first switch circuits, each of which switches a connection state between each of the plurality of first scan electrodes and the first node, the second circuit may include a plurality of second switch circuits, each of which switches a connection state between each of the plurality of second scan electrodes and the first node, the potential control circuit may drop the potential of the first node from the first potential to the second potential in the setup period of the at least one sub-field, the plurality of first switch circuits may connect the plurality of first scan electrodes to the first node, respectively, in a period where the potential of the first node changes from the first potential to the second potential in the setup period of the at least one sub-field, and the plurality of second switch circuits may connect the plurality of second scan electrodes to the first node, respectively, in a period where the potential of the first node changes from the first potential to the third potential, and connect the plurality of second scan electrodes to the second node, respectively, in a period where the potential of the first node changes from the third potential to the second potential in the setup period of the at least one sub-field.

In this case, the potential of the first node drops from the first potential to the second potential by the potential control circuit in the setup period of the at least one sub-field. With the drop, the potential of the second node held at the given potential difference from the first node by the hold circuit drops.

The plurality of first scan electrodes are connected to the first node through the plurality of first switch circuits, respectively, in the period where the potential of the first node changes from the first potential to the second potential. This causes the first ramp waveform to be applied to the first scan electrodes to generate the discharges in the discharge cells on the first scan electrodes.

The plurality of second scan electrodes are connected to the first node through the plurality of second switch circuits, respectively, in the period where the potential of the first node changes from the first potential to the third potential. This causes the second ramp waveform to be applied to the second scan electrodes to generate the discharges in the discharge cells on the second scan electrodes.

When the potential of the first node attains the third potential, the plurality of second scan electrodes are connected to the second node through the plurality of second switch circuits, respectively. Thus, the potential of the plurality of second scan electrodes rise by the given potential difference to attain the fourth potential. After that, the potential of the second node drops, thereby dropping the potential of the plurality of second scan electrodes.

In this manner, the common potential control circuit and the common hold circuit can be used for generating the first ramp waveform and the second ramp waveform, and the common configuration can be employed in the plurality of first switch circuits and the plurality of second switch circuits. Accordingly, the first ramp waveform and the second ramp waveform can be applied to the plurality of first scan electrodes and the plurality of second scan electrodes, respectively, without causing the circuit configuration and operation of the driving device to be complicated.

(6) The plasma display panel may be driven based on an image signal, the driving device of the plasma display panel may further include a luminance level detector that detects an average luminance level of an image in one flame displayed on the plasma display panel based on the image signal, and the first and second circuits may perform the two-phase driving operation in sub-fields, whose number increases, of the plurality of sub-fields as the average luminance level detected by the luminance level detector becomes higher.

In this case, time for the driving operation can be prevented from being insufficient while discharge failures can be reliably prevented from occurring in the discharge cells.

(7) The plurality of sub-fields may have respective luminance weights, and the first and second circuits may perform the two-phase driving operation in a sub-field having a luminance weight of not less than a predetermined luminance weight of the plurality of sub-fields.

In this case, a voltage required for normal lighting of the discharge cells can be efficiently decreased. This allows improvement of driving performance and reduction in driving cost of the plasma display panel.

(8) The plasma display panel may be driven based on an image signal, the driving device of the plasma display panel may further include a lighting rate detector that detects a lighting rate of the plasma display panel based on the image signal, and a selector that selects at least one sub-field of the plurality of sub-fields based on the lighting rate detected by the lighting rate detector, and the first and second circuits may perform the two-phase driving operation in the sub-field selected by the selector.

In this case, the voltage required for normal lighting of the discharge cells can be efficiently decreased. This reliably allows prevention of discharge failures in the discharge cells and reduction in driving cost of the plasma display panel.

(9) The driving device of the plasma display panel may further include a temperature detector that detects a temperature of the plasma display panel, wherein the first and second circuits may perform the two-phase driving operation in sub-fields, whose number increases, of the plurality of sub-fields as the temperature detected by the temperature detector becomes higher.

In this case, the voltage required for normal lighting of the discharge cells can be efficiently decreased. This reliably allows prevention of discharge failures in the discharge cells and reduction in driving cost of the plasma display panel.

(10) According to another aspect of the present invention, a driving device of a plasma display panel drives the plasma display panel including discharge cells at intersections of a plurality of scan electrodes and a plurality of sustain electrodes with a plurality of data electrodes by a sub-field method in which one field period includes a plurality of sub-fields, wherein the plurality of scan electrodes are categorized into a plurality of scan electrode groups including at least first and second scan electrode groups, the driving device of the plasma display panel includes a first circuit that drives the first scan electrode group, and a second circuit that drives the second scan electrode group, the first and second circuits perform a two-phase driving operation in at least one sub-field of the plurality of sub-fields, the first circuit applies a first ramp waveform that drops from a first potential to a second potential to the first scan electrode group in a setup period, and sequentially applies a scan pulse to the first scan electrode group in a write period in the two-phase driving operation, and the second circuit applies a second ramp waveform that drops from the first potential to a third potential that is higher than the second potential to the second scan electrode group and raises a potential of the second scan electrode group to a fourth potential after the second ramp waveform is applied in the setup period, and holds the second scan electrode group at a fifth potential that is higher than the third potential and lower than the fourth potential and sequentially applies a scan pulse to the second scan electrode group after the scan pulse is applied to the first scan electrode group in the write period in the two-phase driving operation.

In the driving device, the two-phase driving operation is performed in the first and second scan electrode groups of the plurality of scan electrode groups by the first and second circuits in the at least one sub-field of the plurality of sub-fields.

In the two-phase driving operation, the first ramp waveform that drops from the first potential to the second potential is applied to the first scan electrode group by the first circuit in the setup period. This generates weak discharges in discharge cells on the scan electrodes belonging to the first scan electrode group, decreasing an amount of wall charges in the discharge cells. As a result, the amount of the wall charges in the discharge cells on the scan electrodes belonging to the first scan electrode group is made suitable for a write operation.

The second ramp waveform that drops from the first potential to the third potential is applied to the second scan electrode group by the second circuit in the setup period. This generates weak discharges in discharge cells on the scan electrodes belonging to the second scan electrode group, decreasing an amount of wall charges in the discharge cells. The potential of the second scan electrode group is subsequently raised to the fourth potential by the second circuit, so that the discharges are stopped in the discharge cells on the scan electrodes belonging to the second scan electrode group.

Here, the first ramp waveform drops to the second potential, whereas the second ramp waveform drops to the third potential that is higher than the second potential. Therefore, an amount of electric charges that transfer in the discharge cells on the scan electrodes belonging to the second scan electrode group is smaller than an amount of electric charges that transfer in the discharge cells on the scan electrodes belonging to the first scan electrode group. This causes a sufficient amount of wall charges to remain in the discharge cells on the scan electrodes belonging to the second scan electrode group at the end of the setup period.

In the write period, the scan pulse is sequentially applied to the first scan electrode group by the first circuit. This generates write discharges in selected discharge cells on the scan electrodes belonging to the first scan electrode group. The scan pulse is sequentially applied to the plurality of second scan electrode groups by the second circuit after the scan pulse is applied to the first scan electrode group. This generates write discharges in selected discharge cells on the scan electrodes belonging to the second scan electrode group.

As described above, the sufficient amount of electric charges remains in the discharge cells on the scan electrodes belonging to the second scan electrode group at the end of the setup period. Therefore, the amount of the wall charges in the discharge cells on the scan electrodes belonging to the second scan electrode group can be made suitable for the write operation at the time of the application of the scan pulse to the second scan electrode group even though the wall charges of the discharge cells on the scan electrodes belonging to the second scan electrode group are decreased during the application of the scan pulse to the first scan electrode group. As a result, discharge failures can be prevented from occurring in the discharge cells on the scan electrodes belonging to the second scan electrode group in the write period.

The write operation can be satisfactorily carried out in the discharge cells on the scan electrodes belonging to the second scan electrode group even though the wall charges are decreased, thus eliminating the necessity of holding the second scan electrode group at a high potential for preventing the wall charges from decreasing in the write period. This allows reduction in driving cost and improvement of driving performance of the plasma display panel.

The discharges are suitably generated in the discharge cells on the scan electrodes belonging to the second scan electrode group in the setup period, thereby preventing excessive electric charges from remaining in the discharge cells at the end of the setup period. This prevents erroneous discharges from occurring in the discharge cells on the scan electrodes belonging to the second scan electrode group at the time of the application of the scan pulse to the first scan electrode group.

The second scan electrode group is held at the fifth potential that is higher than the third potential and lower than the fourth potential in the write period excluding the period where the scan pulse is applied. In this case, the electric charges in the discharge cells on the scan electrodes belonging to the second scan electrode group are in a stable state. This more reliably prevents erroneous discharges from occurring in the discharge cells on the scan electrodes belonging to the second scan electrode group.

(11) According to still another aspect of the present invention, a driving method of a plasma display panel that drives the plasma display panel including discharge cells at intersections of a plurality of first and second scan electrodes and a plurality of sustain electrodes with a plurality of data electrodes by a sub-field method in which one field period includes a plurality of sub-fields includes the steps of applying a first ramp waveform that drops from a first potential to a second potential to the plurality of first scan electrodes in a setup period, and sequentially applying a scan pulse to the plurality of first scan electrodes in a write period in at least one sub-field of the plurality of sub-fields, and applying a second ramp waveform that drops from the first potential to a third potential that is higher than the second potential to the plurality of second scan electrodes and raises a potential of the plurality of second scan electrodes to a fourth potential after the second ramp waveform is applied in the setup period, and holding the plurality of second scan electrodes at a fifth potential that is higher than the third potential and lower than the fourth potential and sequentially applying a scan pulse to the plurality of second scan electrodes after the scan pulse is applied to the plurality of first scan electrodes in the write period in the at least one sub-field.

In the driving method, the first ramp waveform that drops from the first potential to the second potential is applied to the plurality of first scan electrodes in the setup period of the at least one sub-field of the plurality of sub-fields. This generates weak discharges in discharge cells on the first scan electrodes, decreasing an amount of wall charges in the discharge cells. As a result, the amount of the wall charges in the discharge cells on the first scan electrodes is made suitable for a write operation.

The second ramp waveform that drops from the first potential to the third potential is applied to the plurality of second scan electrodes in the setup period. This generates weak discharges in discharge cells on the second scan electrodes, decreasing an amount of wall charges in the discharge cells. The potential of the second scan electrodes is subsequently raised to the fourth potential, so that the discharges are stopped in the discharge cells on the second scan electrodes.

Here, the first ramp waveform drops to the second potential, whereas the second ramp waveform drops to the third potential that is higher than the second potential. Therefore, an amount of electric charges that transfer in the discharge cells on the second scan electrodes is smaller than an amount of electric charges that transfer in the discharge cells on the first scan electrodes. This causes a sufficient amount of wall charge to remain in the discharge cells on the second scan electrodes at the end of the setup period.

In the write period, the scan pulse is sequentially applied to the plurality of first scan electrodes by the first circuit. This generates write discharges in selected discharge cells on the first scan electrodes. The scan pulse is sequentially applied to the plurality of second scan electrodes by the second circuit after the scan pulse is applied to the plurality of first scan electrodes. This generates write discharges in selected discharge cells on the second scan electrodes.

As described above, the sufficient amount of electric charges remains in the discharge cells on the second scan electrodes at the end of the setup period. Therefore, the amount of the wall charges in the discharge cells on the second scan electrodes can be made suitable for the write operation at the time of the application of the scan pulse to the second scan electrodes even though the wall charges of the discharge cells on the second scan electrodes are decreased during the application of the scan pulse to the first scan electrodes. As a result, discharge failures can be prevented from occurring in the discharge cells on the second scan electrodes in the write period.

The write operation can be satisfactorily carried out in the discharge cells on the second scan electrodes even though the wall charges are decreased, thus eliminating the necessity of holding the second scan electrodes at a high potential for preventing the wall charges from decreasing in the write period. This allows reduction in driving cost and improvement of driving performance of the plasma display panel.

The discharges are suitably generated in the discharge cells on the second scan electrodes in the setup period, thereby preventing excessive electric charges from remaining in the discharge cells at the end of the setup period. This prevents erroneous discharges from occurring in the discharge cells on the second scan electrodes at the time of the application of the scan pulse to the first scan electrodes.

The second scan electrodes are held at the fifth potential that is higher than the third potential and lower than the fourth potential in the write period excluding the period where the scan pulse is applied. In this case, the electric charges in the discharge cells on the second scan electrodes are in a stable state. This more reliably prevents erroneous discharges from occurring in the discharge cells on the second scan electrodes.

(12) According to yet another aspect of the present invention, a plasma display apparatus includes a plasma display panel that includes discharge cells at intersections of a plurality of first and second scan electrodes and a plurality of sustain electrodes with a plurality of data electrodes, and a driving device that drives the plasma display panel by a sub-field method in which one field period includes a plurality of sub-fields, wherein the driving device includes a first circuit that drives the plurality of first scan electrodes, and a second circuit that drives the plurality of second scan electrodes, the first and second circuits perform a two-phase driving operation in at least one sub-field of the plurality of sub-fields, the first circuit applies a first ramp waveform that drops from a first potential to a second potential to the plurality of first scan electrodes in a setup period, and sequentially applies a scan pulse to the plurality of first scan electrodes in a write period in the two-phase driving operation, and the second circuit applies a second ramp waveform that drops from the first potential to a third potential that is higher than the second potential to the plurality of second scan electrodes and raises a potential of the plurality of second scan electrodes to a fourth potential after the second ramp waveform is applied in the setup period, and holds the plurality of second scan electrodes at a fifth potential that is higher than the third potential and lower than the fourth potential and sequentially applies a scan pulse to the plurality of second scan electrodes after the scan pulse is applied to the plurality of first scan electrodes in the write period in the two-phase driving operation.

In the plasma display apparatus, the plasma display panel is driven by the driving device using the sub-field method in which one field period includes the plurality of sub-fields. The two-phase driving operation is performed by the first and second circuits of the driving device in the at least one sub-field of the plurality of sub-fields.

In the two-phase driving operation, the first ramp waveform that drops from the first potential to the second potential is applied to the plurality of first scan electrodes by the first circuit in the setup period. This generates weak discharges in discharge cells on the first scan electrodes, decreasing an amount of wall charges in the discharge cells. As a result, an amount of the wall charges in the discharge cells on the first scan electrodes is made suitable for a write operation.

The second ramp waveform that drops from the first potential to the third potential is applied to the plurality of second scan electrodes by the second circuit in the setup period. This generates weak discharges in discharge cells on the second scan electrodes, decreasing an amount of wall charges in the discharge cells. The potential of the second scan electrodes is subsequently raised to the fourth potential by the second circuit, so that the discharges are stopped in the discharge cells on the second scan electrodes.

Here, the first ramp waveform drops to the second potential, whereas the second ramp waveform drops to the third potential that is higher than the second potential. Therefore, an amount of electric charges that transfer in the discharge cells on the second scan electrodes is smaller than an amount of electric charges that transfer in the discharge cells on the first scan electrodes. This causes a sufficient amount of wall charges to remain in the discharge cells on the second scan electrodes at the end of the setup period.

In the write period, the scan pulse is sequentially applied to the plurality of first scan electrodes by the first circuit. This generates write discharges in selected discharge cells on the first scan electrodes. The scan pulse is sequentially applied to the plurality of second scan electrodes by the second circuit after the scan pulse is applied to the plurality of first scan electrodes. This generates write discharges in selected discharge cells on the second scan electrodes.

As described above, the sufficient amount of electric charges remains in the discharge cells on the second scan electrodes at the end of the setup period. Therefore, the amount of the wall charges in the discharge cells on the second scan electrodes can be made suitable for the write operation at the time of the application of the scan pulse to the second scan electrodes even though the wall charges of the discharge cells on the second scan electrodes are decreased during the application of the scan pulse to the first scan electrodes. As a result, discharge failures can be prevented from occurring in the discharge cells on the second scan electrodes in the write period.

The write operation can be satisfactorily carried out in the discharge cells on the second scan electrodes even though the wall charges are decreased, thus eliminating the necessity of holding the second scan electrodes at a high potential for preventing the wall charges from decreasing in the write period. This allows reduction in driving cost and improvement of driving performance of the plasma display panel.

The discharges are suitably generated in the discharge cells on the second scan electrodes in the setup period, thereby preventing excessive electric charges from remaining in the discharge cells at the end of the setup period. This prevents erroneous discharges from occurring in the discharge cells on the second scan electrodes at the time of the application of the scan pulse to the first scan electrodes.

The second scan electrodes are held at the fifth potential that is higher than the third potential and lower than the fourth potential in the write period excluding the period where the scan pulse is applied. In this case, the electric charges in the discharge cells on the second scan electrodes are in a stable state. This more reliably prevents erroneous discharges from occurring in the discharge cells on the second scan electrodes.

### [Effects of the Invention]

According to the present invention, the amount of the wall charges in the discharge cells on the second scan electrodes can be made suitable for the write operation at the time of the application of the scan pulse to the second scan electrodes even though the wall charges of the discharge cells on the second scan electrodes are decreased during the application of the scan pulse to the first scan electrodes. As a result, discharge failures can be prevented from occurring in the discharge cells on the second scan electrodes in the write period.

### BRIEF DESCRIPTION OF THE DRAWINGS

FIG. 1 is an exploded perspective view showing part of a plasma display panel in a plasma display apparatus according to a first embodiment.

FIG. 2 is a diagram showing an arrangement of electrodes of the panel in the first embodiment.

FIG. 3 is a block diagram of circuits in the plasma display apparatus according to the first embodiment of the present invention.

FIG. 4 is a driving waveform diagram in a sub-field configuration of the plasma display apparatus of FIG. 3.

FIG. 5 is a driving waveform diagram in the sub-field configuration of the plasma display apparatus of FIG. 3.

FIG. 6 is a diagram showing relationships between changes in potentials of scan electrode groups and amounts of electric charges generated by discharge in discharge cells in a second SF.

FIG. 7 is a circuit diagram showing the configuration of a scan electrode drive circuit.

FIG. 8 is a diagram showing correspondences among respective logic of control signals and states of scan ICs.

FIG. 9 is a detailed timing chart of control signals applied to transistors in a two-phase driving operation of the scan electrode drive circuit.

FIG. 10 is a detailed timing chart of the control signals applied to the transistors in the two-phase driving operation of the scan electrode drive circuit.

FIG. 11 is a detailed timing chart of the control signals applied to the transistors in the two-phase driving operation of the scan electrode drive circuit.

FIG. 12 is a detailed timing chart of the control signals applied to the transistors in the two-phase driving operation of the scan electrode drive circuit.

FIG. 13 is a detailed timing chart of the control signals applied to the transistors in a one-phase driving operation of the scan electrode drive circuit.

FIG. 14 is a detailed timing chart of the control signals applied to the transistors in the one-phase driving operation of the scan electrode drive circuit.

FIG. 15 is a detailed timing chart of the control signals applied to the transistors in the one-phase driving operation of the scan electrode drive circuit.

FIG. 16 is a diagram showing the configuration of a comparison circuit and its periphery.

FIG. 17 is a diagram showing a relationship between an APL and an excess time.

FIG. 18 is a diagram showing one example of a selection condition of the one-phase driving operation and the two-phase driving operation.

FIG. 19 is a diagram showing values of a voltage Vscn required for normal lighting of each discharge cell in each sub-field.

FIG. 20 is a block diagram of circuits in a plasma display apparatus according to a third embodiment.

FIG. 21 is a diagram showing a relationship between a lighting rate and the required voltage when scan electrodes are driven by the one-phase driving operation.

FIG. 22 is a flowchart showing setting operation of sub-fields by a calculator.

FIG. 23 is a diagram showing examples of setting of one-phase SFs and two-phase SFs.

FIG. 24 is a block diagram of circuits in a plasma display apparatus according to a fourth embodiment.

FIG. 25 is a diagram showing a relationship between the temperature of the panel and the required voltage when the scan electrodes are driven by the one-phase driving operation.

FIG. 26 is a diagram showing examples of setting of the one-phase SFs and the two-phase SFs.

### BEST MODE FOR CARRYING OUT THE INVENTION

The embodiments of the present invention will be described in detail referring to the drawings. The embodiments below describe a driving device and a driving method of a plasma display panel and a plasma display apparatus.

### (1) First Embodiment

(1-1) Configuration of Panel

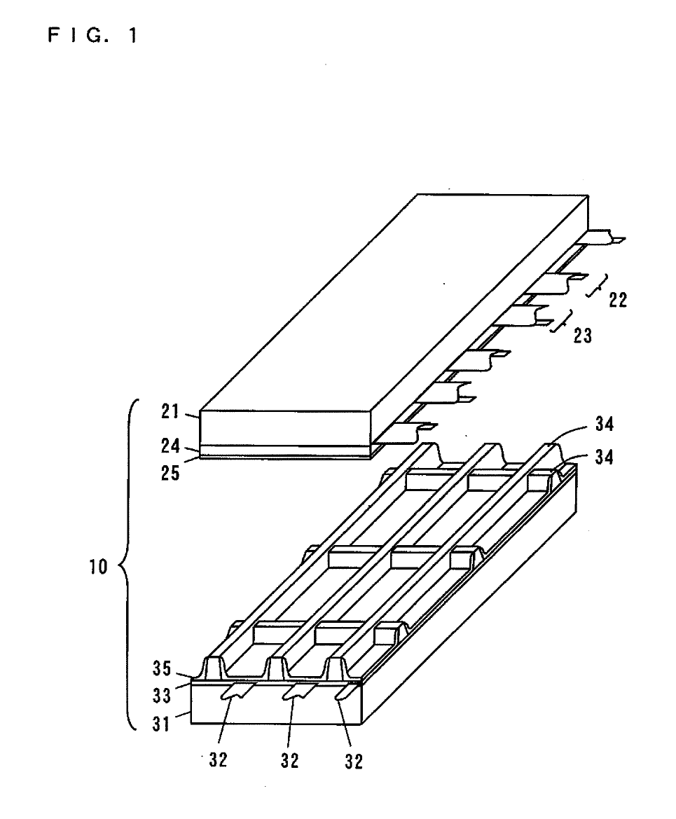

FIG. 1 is an exploded perspective view showing part of a plasma display panel in a plasma display apparatus according to a first embodiment of the present invention.

The plasma display panel (hereinafter abbreviated as the panel) 10 includes a front substrate 21 and a back substrate 31 that are made of glass and arranged to face each other. A discharge space is formed between the front substrate 21 and the back substrate 31. A plurality of pairs of scan electrodes 22 and sustain electrodes 23 are formed in parallel with one another on the front substrate 21. Each pair of scan electrode 22 and sustain electrode 23 constitutes a display electrode. A dielectric layer 24 is formed to cover the scan electrodes 22 and the sustain electrodes 23, and a protective layer 25 is formed on the dielectric layer 24.

A plurality of data electrodes 32 covered with an insulator layer 33 are provided on the back substrate 31, and barrier ribs 34 are provided in a shape of a number sign on the insulator layer 33. Phosphor layers 35 are provided on a surface of the insulator layer 33 and side surfaces of the barrier ribs 34. Then, the front substrate 21 and the back substrate 31 are arranged to face each other such that the plurality of pairs of scan electrodes 22 and sustain electrodes 23 vertically intersect with the plurality of data electrodes 32, and the discharge space is formed between the front substrate 21 and the back substrate 31. The discharge space is filled with a mixed gas of neon and xenon, for example, as a discharge gas. Note that the configuration of the panel is not limited to the configuration described above. A configuration including the barrier ribs in a striped shape may be employed, for example.

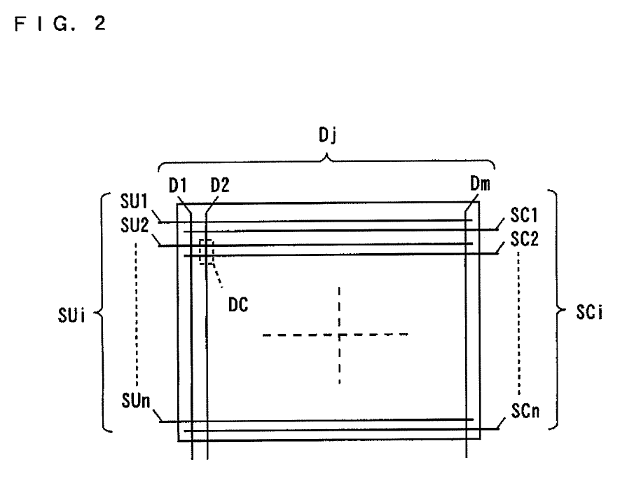

FIG. 2 is a diagram showing an arrangement of the electrodes of the panel in the first embodiment of the present invention. N scan electrodes SC1 to SCn (the scan electrodes 22 of FIG. 1) and n sustain electrodes SU1 to SUn (the sustain electrodes 23 of FIG. 1) are arranged along a row direction, and m data electrodes D1 to Dm (the data electrodes 32 of FIG. 1) are arranged along a column direction. N is an even number, and m is a natural number of not less than two. A discharge cell DC is formed at an intersection of a pair of scan electrode SCi (i=1 to n) and sustain electrode SUi (i=1 to n) with one data electrode Dj (j=1 to m). Accordingly, m×n discharge cells are formed in the discharge space.

(1-2) Configuration of the Plasma Display Apparatus

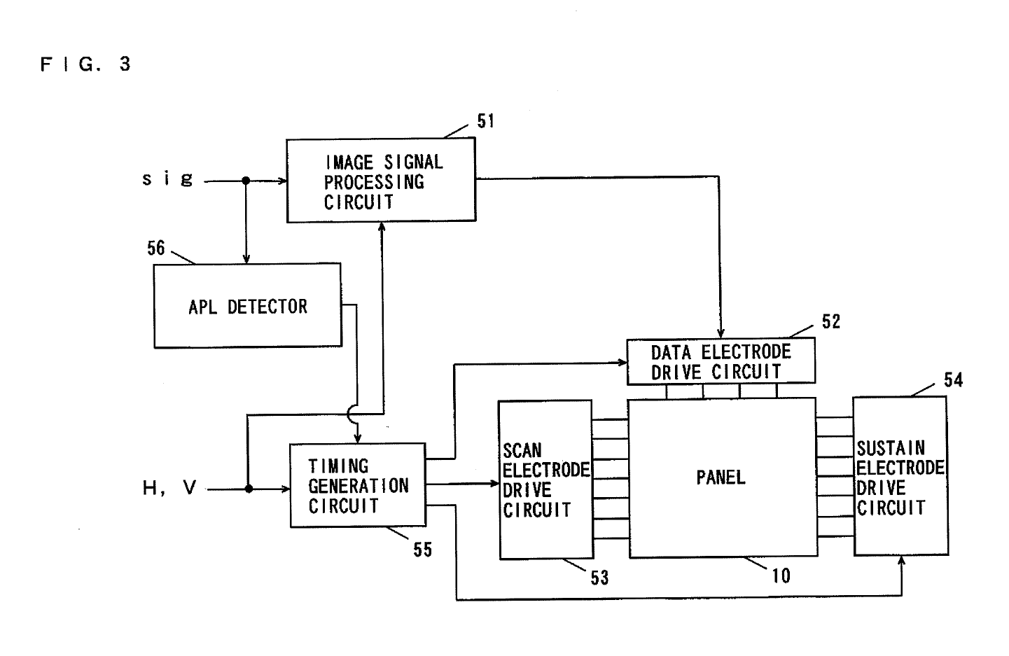

FIG. 3 is a block diagram of circuits in the plasma display apparatus according to the first embodiment of the present invention.

The plasma display apparatus includes the panel 10, an image signal processing circuit 51, a data electrode drive circuit 52, a scan electrode drive circuit 53, a sustain electrode drive circuit 54, a timing generation circuit 55, an APL detector 56 and a power supply circuit (not shown).

The image signal processing circuit 51 converts an image signal sig into image data corresponding to the number of pixels of the panel 10, divides the image data on each pixel into a plurality of bits corresponding to a plurality of sub-fields, and outputs them to the data electrode drive circuit 52.

The data electrode drive circuit 52 converts the image data for each sub-field into signals corresponding to the data electrodes D1 to Dm, respectively, and drives the data electrodes D1 to Dm based on the respective signals.

The APL detector 56 detects an APL (Average Picture Level) of the image signals sig, and outputs a signal indicating the detected APL to the timing generation circuit 55. Here, the APL means an average of luminance levels of the image signal sig in one frame, and represents overall brightness of the image in one screen. In the present embodiment, one frame equals to one field.

The timing generation circuit 55 generates a timing signal based on a horizontal synchronizing signal H, a vertical synchronizing signal V, and the average picture level (APL) detected by the APL detector 56, and supplies the timing signal to each of the drive circuit blocks (the image signal processing circuit 51, the data electrode drive circuit 52, the scan electrode drive circuit 53 and the sustain electrode drive circuit 54).

The scan electrode drive circuit 53 supplies driving waveforms to the scan electrodes SC1 to SCn based on the timing signal, and the sustain electrode drive circuit 54 supplies driving waveforms to the sustain electrodes SU1 to SUn based on the timing signal.

The scan electrode drive circuit 53 is capable of selectively performing in the setup period a one-phase driving operation in which the same driving waveforms are applied to all the scan electrodes SC1 to SCn and a two-phase driving operation in which different driving waveforms are applied to the scan electrodes SC1, SC3, . . . , SCn−1 and the scan electrodes SC2, SC4, . . . , SCn, as described below.

The timing generation circuit 55 selectively generates a timing signal for the one-phase driving operation and a timing signal for the two-phase driving operation based on the APL detected by the APL detector 56, and supplies the generated timing signal to the scan electrode drive circuit 53 in the present embodiment. This causes the scan electrodes SC1 to SCn to be driven by the one-phase driving operation or the two-phase driving operation.

In the following description, the scan electrodes SC1, SC3, . . . , SCn−1 are referred to as a first scan electrode group, and the scan electrodes SC2, SC4, . . . , SCn are referred to as a second scan electrode group. The sustain electrodes SU1, SU3, . . . , SUn−1 are referred to as a first sustain electrode group, and the sustain electrodes SU2, SU4, . . . , SUn are referred to as a second sustain electrode group. A plurality of discharge cells constituted by the first scan electrode group and the first sustain electrode group are referred to as a first discharge cell group, and a plurality of discharge cells constituted by the second scan electrode group and the second sustain electrode group are referred to as a second discharge cell group.

(1-3) Sub-Field Configuration

Next, a sub-field configuration is explained. In a sub-field method, one field (1/60 seconds=16.67 msec) is divided into a plurality of sub-fields on the time base, and respective luminance weights are set for the plurality of sub-fields.

For example, one field is divided into ten sub-fields (hereinafter referred to as a first SF, a second SF, . . . , and a tenth SF) on the time base, and the sub-fields have the luminance weights of 1, 2, 3, 6, 11, 18, 30, 44, 60 and 81, respectively.

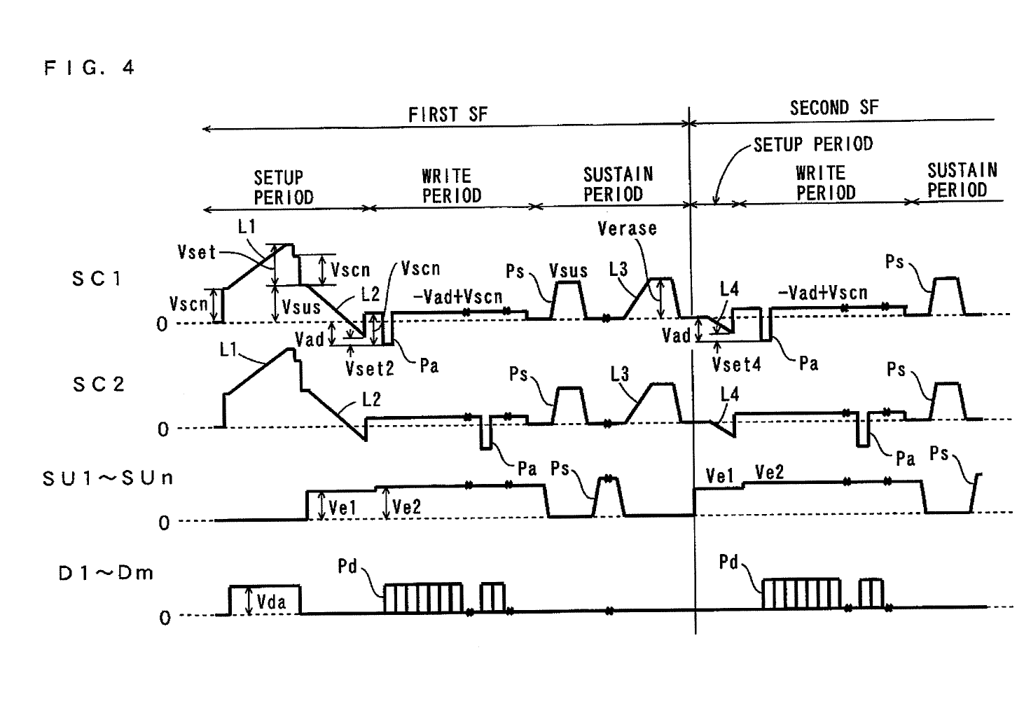

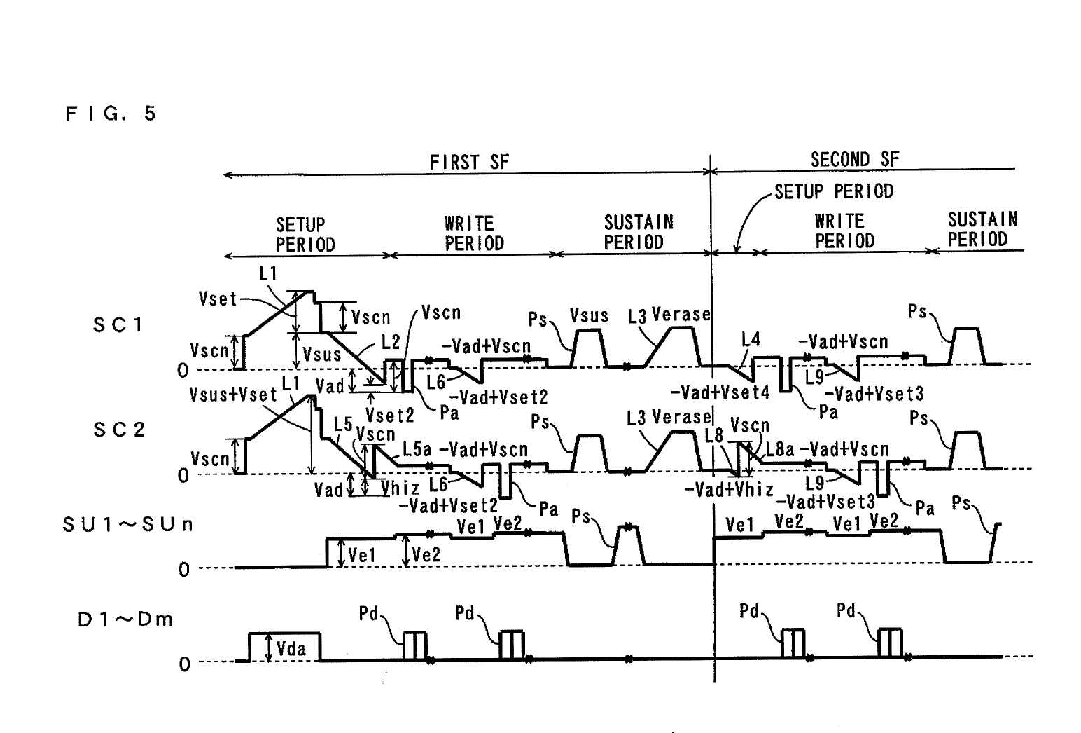

FIGS. 4 and 5 are driving waveform diagrams in the sub-field configuration of the plasma display apparatus of FIG. 3. Note that FIG. 4 shows driving waveforms applied to respective electrodes in the one-phase driving operation of the scan electrode drive circuit 53, and FIG. 5 shows driving waveforms applied to the respective electrodes in the two-phase driving operation of the scan electrode drive circuit 53.

FIGS. 4 and 5 show the driving waveforms of the one scan electrode SC1 of the first scan electrode group, the one scan electrode SC2 of the second scan electrode group, the sustain electrodes SU1 to SUn, and the data electrodes D1 to Dm. A period from a setup period of the first SF to a sustain period of the second SF in one field is shown in FIGS. 4 and 5.

(a) The Driving Waveforms in the One-Phase Driving Operation

First, description is made of the driving waveforms applied to the respective electrodes in the one-phase driving operation of the scan electrode drive circuit 53.

As shown in FIG. 4, in the first half of the setup period of the first SF, the potential of the data electrodes D1 to Dm is held at Vda, the sustain electrodes SU1 to SUn are held at 0 V (the ground potential), and a ramp waveform L1 is applied to each of the scan electrodes SC1 to SCn.

The ramp waveform L1 gradually rises from a positive potential Vscn that is not more than a discharge start voltage toward a positive potential (Vsus+Vset) that exceeds the discharge start voltage. Then, first weak setup discharges are induced in all the discharge cells, so that negative wall charges are stored on the scan electrodes SC1 to SCn while positive wall charges are stored on the sustain electrodes SU1 to SUn and the data electrodes D1 to Dm, respectively. Here, a voltage caused by wall charges stored on the dielectric layer, the phosphor layer and so on covering the electrode is referred to as a wall voltage on the electrode.

In the subsequent second half of the setup period, the data electrodes D1 to Dm are held at the ground potential, the sustain electrodes SU1 to SUn are held at a positive potential Ve1, and a ramp waveform L2 that gradually drops from the positive potential (Vsus) toward a negative potential (−Vad+Vset2) is applied to each of the scan electrodes SC1 to SCn. Then, second weak setup discharges are induced in all the discharge cells, so that the wall voltage on the scan electrode SCi and the wall voltage on the sustain electrode SUi are weakened, and the wall voltage on the data electrode Dk is adjusted to a value suitable for a write operation in all the discharge cells.

In the first half of a write period of the first SF, the sustain electrodes SU1 to SUn are temporarily held at a potential Ve2, and the scan electrodes SC1 to SCn are temporarily held at a potential (−Vad+Vscn). Next, a positive write pulse Pd (=Vda) is applied to a data electrode Dk (k is any of 1 to m), among the data electrodes D1 to Dm, of the discharge cell that should emit light on a first row while a negative scan pulse Pa (=−Vad) is applied to the scan electrode SC1 on the first row. Then, a voltage at an intersection of the data electrode Dk and the scan electrode SC1 attains a value obtained by adding the wall voltage on the data electrode Dk and the wall voltage on the scan electrode SC1 to an externally applied voltage (Pd−Pa), exceeding the discharge start voltage. This generates a write discharge between the data electrode Dk and the scan electrode SC1 and between the sustain electrode SU1 and the scan electrode SC1. As a result, in the discharge cell, the positive wall charges are stored on the scan electrode SC1, the negative wall charges are stored on the sustain electrode SU1 and the negative wall charges are stored on the data electrode Dk.

In this manner, the write operation for generating the write discharge in the discharge cell that should emit light on the first row to cause the wall charges to be stored on each of the electrodes is performed. On the other hand, since a voltage at an intersection of a data electrode Dh (h≠k) to which the write pulse Pd has not been applied and the scan electrode SC1 does not exceed the discharge start voltage, the write discharge is not generated.

The above-described write operation is sequentially performed in the discharge cells on the first row to the n−1-th row of the first discharge cell group, and then the same write operation is sequentially performed in the discharge cells on the second row to the n-th row of the second discharge cell group. In this case, the scan pulse Pa is sequentially applied to the scan electrodes SC1, SC3, . . . , SCn−1 of the first scan electrode group, and then the scan pulse Pa is sequentially applied to the scan electrodes SC2, SC4, . . . , SCn of the second scan electrode group in the write period.

In a subsequent sustain period, the sustain electrodes SU1 to SUn are returned to the ground potential, and a sustain pulse Ps (=Vsus) is applied to the scan electrodes SC1 to SCn for the first time in the sustain period. At this time, in the discharge cell in which the write discharge has been generated in the write period, a voltage between the scan electrode SCi and the sustain electrode SUi attains a value obtained by adding the wall voltage on the scan electrode SCi and the wall voltage on the sustain electrode SUi to the sustain pulse Ps (=Vsus), exceeding the discharge start voltage. This induces a sustain discharge between the scan electrode SCi and the sustain electrode SUi, causing the discharge cell to emit light. As a result, the negative wall charges are stored on the scan electrode SCi, the positive wall charges are stored on the sustain electrode SUi, and the positive wall charges are stored on the data electrode Dk.

In the discharge cell in which the write discharge has not been generated in the write period, the sustain discharge is not induced and the wall charges are held in a state at the end of the setup period. Next, the scan electrodes SC1 to SCn are returned to the ground potential, and the sustain pulse Ps is applied to the sustain electrodes SU1 to SUn. Then, since the voltage between the sustain electrode SUi and the scan electrode SCi exceeds the discharge start voltage in the discharge cell in which the sustain discharge has been induced, the sustain discharge is again induced between the sustain electrode SUi and the scan electrode SCi, the negative wall charges are stored on the sustain electrode SUi, and the positive wall charges are stored on the scan electrode SCi.

Similarly, a predetermined number of sustain pulses Ps are alternately applied to the respective scan electrodes SC1 to SCn and sustain electrodes SU1 to SUn, so that the sustain discharges are continuously performed in the discharge cells in which the write discharges have been generated in the write period.

After the sustain pulse Ps is applied, a ramp waveform L3 is applied to each of the scan electrodes SC1 to SCn while the sustain electrodes SU1 to SUn and the data electrodes D1 to Dm are held at the ground potential. The ramp waveform L3 gradually rises from the ground potential toward a positive potential Verase. This causes the voltage between the scan electrode SCi and the sustain electrode SUi to exceed the discharge start voltage, so that a weak erase discharge is generated between the sustain electrode SUi and the scan electrode SCi in the discharge cell in which the sustain discharge has been induced.

As a result, the negative wall charges are stored on the scan electrode SCi and the positive wall charges are stored on the sustain electrode SUi. At this time, the positive wall charges are stored on the data electrode Dk. Then, the scan electrodes SC1 to SCn are returned to the ground potential, and a sustain operation in the sustain period is finished.

In a setup period of the second SF, the sustain electrodes SU1 to SUn are held at the potential Ve1, the data electrodes D1 to Dm are held at the ground potential, and a ramp waveform L4 that gradually drops from the ground potential toward a negative potential (−Vad+Vset4) is applied to the scan electrodes SC1 to SCn. Note that Vset4 is larger than Vset2. That is, the potential (−Vad+Vset4) is higher than the potential (−Vad+Vset2).

Then, weak setup discharges are generated in the discharge cells in which the sustain discharges have been induced in the sustain period of the preceding sub-field (the first SF in FIG. 4). Accordingly, the wall voltages on the scan electrode SCi and the sustain electrode SUi are weakened, and the wall voltage on the data electrode Dk is also adjusted to the value suitable for the write operation in the discharge cells in which the sustain discharges have been induced in the preceding sub-field.

The discharges are not generated and the wall charges are kept constant in the state at the end of the setup period of the preceding sub-field in the discharge cells in which the sustain discharges have not been induced in the preceding sub-field.

In a write period of the second SF, the same driving waveforms as those in the write period of the first SF are applied to the scan electrodes SC1 to SCn, the sustain electrodes SU1 to SUn and the data electrodes D1 to Dm.

The predetermined number of sustain pulses Ps are alternately applied to the scan electrodes SC1 to SCn and the sustain electrodes SU1 to SUn in the sustain period of the second SF similarly to the sustain period of the first SF. Accordingly, the sustain discharges are performed in the discharge cells in which the write discharges have been generated in the write period.

The same driving waveforms as those in the second SF are applied to the first scan electrode group, the second scan electrode group, the sustain electrodes SU1 to SUn and the data electrodes D1 to Dm in the third SF and the subsequent SFs.

Note that the number of the sustain pulses Ps applied to the scan electrodes SC1 to SCn in the sustain period is set to decrease as the APL detected by the APL detector 56 attains a higher level in the present embodiment.

(b) Driving Waveforms in the Two-Phase Driving Operation

Next, description is made of driving waveforms applied to the respective electrodes in the two-phase driving operation of the scan electrode drive circuit 53. Note that the ramp waveforms L1 to L4 shown in FIG. 5 are the same as those of FIG. 4.

In the first half of the setup period of the first SF, the potential of the data electrodes D1 to Dm are held at Vda, the sustain electrodes SU1 to SUn are held at the ground potential, and the ramp waveform L1 is applied to each of the scan electrodes SC1 to SCn. Thus, the first weak setup discharges are induced in all the discharge cells, so that the negative wall charges are stored on the scan electrodes SC1 to SCn while the positive wall charges are stored on the sustain electrodes SU1 to SUn and the data electrodes D1 to Dm, respectively.

In the subsequent second half of the setup period, the data electrodes D1 to Dm are held at the ground potential, the sustain electrodes SU1 to SUn are held at the positive potential Ve1, and the ramp waveform L2 that gradually drops from Vsus toward (−Vad+Vset2) is applied to the first scan electrode group (the scan electrodes SC1, SC3, . . . , SCn−1). Then, the second weak setup discharges are induced in the first discharge cell group, so that the wall voltage on the scan electrode SCi and the wall voltage on the sustain electrode SUi are weakened, and the wall voltage on the data electrode Dk is adjusted to the value suitable for the write operation in the first discharge cell group.

On the other hand, a ramp waveform L5 that gradually drops from Vsus toward (−Vad+Vhiz) is applied to the second scan electrode group (the scan electrodes SC2, SC4, . . . , SCn). Then, the potential of the second scan electrode group is raised to (−Vad+Vhiz+Vscn), and a ramp waveform L5a that gradually drops from (−Vad+Vhiz+Vscn) toward (−Vad+Vscn) is subsequently applied to the second scan electrode group. Note that Vhiz is larger than each of Vset2 and Vset4. In this case, second weak setup discharges are induced in the second discharge cell group during application of the ramp waveform L5.

Here, the ramp waveform L2 applied to the first scan electrode group drops to (−Vad+Vset2), whereas the ramp waveform L5 applied to the second scan electrode group drops to (−Vad+Vhiz) that is higher than (−Vad+Vset2). Therefore, the amount of electric charges that transfer due to the second setup discharges in the second discharge cell group is smaller than that in the first discharge cell group. This causes a larger amount of wall charges to be held in the second discharge cell group than in the first discharge cell group after the second setup discharges.

In the first half of the write period of the first SF, the write operation is sequentially performed in the discharge cells on the first row to the n−1-th row of the first discharge cell group as described referring to FIG. 4.

After the write operation in the first discharge cell group is finished, the sustain electrodes SU1 to SUn are held at the potential Ve1, and a ramp waveform L6 that gradually drops from the ground potential toward the negative potential (−Vad+Vset2) is applied to all the scan electrodes SC1 to SCn.

Here, the scan pulse Pa is not applied to the second scan electrode group in a period where the scan pulse Pa is applied to the first scan electrode group. The wall charges of the second discharge cell group are decreased in this period. As described above, however, the larger amount of wall charges are held in the second discharge cell group than in the first discharge cell group at a time point where the setup period is finished. Accordingly, a sufficient amount of wall charges is held in the second discharge cell group even though the wall charges in the second discharge cell group are decreased in the foregoing period.

In the present embodiment, the ramp waveform L6 that gradually drops from the ground potential toward the negative potential (−Vad+Vset2) is applied to each of the scan electrodes SC1 to SCn immediately before the scan pulse Pa is applied to the second scan electrode group. Then, third weak setup discharges are induced in the second discharge cell group. Thus, the wall voltages on the scan electrode SCi and the sustain electrode SUi are weakened, and the wall voltage on the data electrode Dk is also adjusted to the value suitable for the write operation in the second discharge cell group.

That is, the setup operation for all discharge cells belonging to the first discharge cell group (the setup operation for all cells of the first discharge cell group) is performed in the setup period of the first SF, and the setup operation for all discharge cells belonging to the second discharge cell group (the setup operation for all cells of the second discharge cell group) is performed in the setup period and the write period of the first SF in the two-phase driving operation of the scan electrode drive circuit 53.

While the ramp waveform L6 drops from the ground potential in the present embodiment, the ramp waveform L6 may drop from another potential. For example, the ramp waveform L6 may drop from (−Vad+Vscn), and may drop from a potential that is higher than (−Vad+Vscn).

In the second half of the write period of the first SF (after the application of the ramp waveform L6), the sustain electrodes SU1 to SUn are again held at the potential Ve2, and the scan electrodes SC1 to SCn are temporarily held at the potential (−Vad+Vscn). Next, the positive write pulse Pd is applied to a data electrode Dk, among the data electrodes D1 to Dm, of the discharge cell that should emit light on the second row while the negative scan pulse Pa is applied to the scan electrode SC2 on the second row. Then, a voltage at an intersection of the data electrode Dk and the scan electrode SC2 exceeds the discharge start voltage. This generates the write discharge between the data electrode Dk and the scan electrode SC2 and between the sustain electrode SU2 and the scan electrode SC2. As a result, in the discharge cell, the positive wall charges are stored on the scan electrode SC2, the negative wall charges are stored on the sustain electrode SU2 and the negative wall charges are stored on the data electrode Dk.

In this manner, the write operation for generating the write discharge in the discharge cell that should emit light on the second row to cause the wall charges to be stored on each of the electrodes is performed. On the other hand, since a voltage at an intersection of a data electrode Dh to which the write pulse Pd has not been applied and the scan electrode SC2 does not exceed the discharge start voltage, the write discharge is not generated.

The above-described write operation is sequentially performed in the discharge cells on the second row to the n-th row of the second discharge cell group, and the write period is finished. In the subsequent sustain period, the sustain pulses Ps are alternately applied to the scan electrodes SC1 to SCn and the sustain electrodes SU1 to SUn as described referring to FIG. 4. Thus, the sustain discharges are generated in the discharge cells in which the write discharges have been generated in the write period.

After the application of the sustain pulse Ps, the ramp waveform L3 is applied to each of the scan electrodes SC1 to SCn as described referring to FIG. 4. Accordingly, the weak erase discharges are generated in the discharge cells in which the sustain discharges have been induced.

As a result, the negative wall charges are stored on the scan electrode SCi and the positive wall charges are stored on the sustain electrode SUi. At this time, the positive wall charges are stored on the data electrode Dk. Then, the scan electrodes SC1 to SCn are returned to the ground potential, and the sustain operation in the sustain period is finished.

In the setup period of the second SF, the sustain electrodes SU1 to SUn are held at the potential Ve1, the data electrodes D1 to Dm are held at the ground potential, and the ramp waveform L4 that gradually drops from the ground potential toward (−Vad+Vset4) is applied to the first scan electrode group (the scan electrodes SC1, SC3, . . . , SCn−1).

Then, the weak setup discharges are generated in the discharge cells of the first discharge cell group in which the sustain discharges have been induced in the sustain period of the preceding sub-field (the first SF in FIG. 5). Accordingly, the wall voltages on the scan electrode SCi and the sustain electrode SUi are weakened, and the wall voltage on the data electrode Dk is also adjusted to the value suitable for the write operation in the discharge cells of the first discharge cell group in which the sustain discharges have been induced in the preceding sub-field.

The discharges are not generated and the wall charges are kept constant in the state at the end of the setup period of the preceding sub-field in the discharge cells in which the sustain discharges have not been induced in the preceding sub-field of the first discharge cell group.

On the other hand, a ramp waveform L8 that gradually drops from the ground potential toward (−Vad+Vhiz) is applied to the second scan electrode group (the scan electrodes SC2, SC4, . . . , SCn). Then, the potential of the second scan electrode group is raised to (−Vad+Vhiz+Vscn), a ramp waveform L8a that gradually drops from (−Vad+Vhiz+Vscn) toward (−Vad+Vscn) is subsequently applied to the second scan electrode group.

In this case, the weak setup discharges are generated during the application of the ramp waveform L8 in the discharge cells of the second discharge cell group in which the sustain discharges have been induced in the sustain period of the preceding sub-field.

Here, the ramp waveform L4 applied to the first scan electrode group drops to (−Vad+Vset4), whereas the ramp waveform L8 applied to the second scan electrode group drops to (−Vad+Vhiz) that is higher than (−Vad+Vset4). Therefore, the amount of electric charges that transfer in the second discharge cell group is smaller than that in the first discharge cell group. This causes a larger amount of wall charges to be stored in the discharge cells of the second discharge cell group in which the sustain discharges have been induced in the preceding sub-field than in the discharge cells of the first discharge cell group.

Note that the discharges are not generated in the discharge cells of the second discharge cell group in which the sustain discharges have not been induced in the preceding sub-field.

In the first half of the write period of the second SF, the same driving waveforms as those in the first half of the write period of the first SF are applied to the first scan electrode group, the second scan electrode group, the sustain electrodes SU1 to SUn and the data electrodes D1 to Dm.

After the write operation in the first discharge cell group is finished, the sustain electrodes SU1 to SUn are held at the potential Ve1, and a ramp waveform L9 that gradually drops from the ground potential toward a negative potential (−Vad+Vset3) is applied to all the scan electrodes SC1 to SCn. Note that Vset3 is larger than Vset2 and smaller than Vset4.

Here, the scan pulse Pa is not applied to the second scan electrode group in a period where the scan pulse Pa is applied to the first scan electrode group in the write period of the second SF. The wall charges of the second discharge cell group are decreased in this period. As described above, however, a large amount of wall charges are held at the end of the setup period of the second SF in the discharge cells of the second discharge cell group in which the sustain discharges have been induced in the preceding sub-field. Accordingly, a sufficient amount of wall charges is held in the discharge cells even though the wall charges in the discharge cells are decreased in the foregoing period.

In the present embodiment, the ramp waveform L9 that gradually drops from the ground potential toward the negative potential (−Vad+Vset3) is applied to each of the scan electrodes SC1 to SCn immediately before the scan pulse Pa is applied to the second scan electrode group. Then, the weak setup discharges are induced in the discharge cells of the second discharge cell group in which the sustain discharges have been induced in the preceding sub-field. Thus, the wall voltages on the scan electrode SCi and the sustain electrode SUi are weakened, and the wall voltage on the data electrode Dk is also adjusted to the value suitable for the write operation in the discharge cells of the second discharge cell group in which the sustain discharges have been induced in the preceding sub-field.

That is, the selective setup operation is performed in the first discharge cell group in the setup period of the second SF, and the selective setup operation is performed in the second discharge cell group in the setup period and the write period of the second SF in the two-phase driving operation of the scan electrode drive circuit 53. Note that the selective setup operation means an operation for selectively generating the setup discharges in the discharge cells in which the sustain discharges have been induced in the immediately preceding sub-field.

In the second half of the write period of the second SF, the same driving waveforms as those in the second half of the write period of the first SF are applied to the first scan electrode group, the second scan electrode group, the sustain electrodes SU1 to SUn and the data electrodes D1 to Dm.

The predetermined number of sustain pulses Ps are alternately applied to the scan electrodes SC1 to SCn and the sustain electrodes SU1 to SUn in the sustain period of the second SF similarly to the sustain period of the first SF. Accordingly, the sustain discharges are performed in the discharge cells in which the write discharges have been generated in the write period.

The same driving waveforms as those in the second SF are applied to the first scan electrode group, the second scan electrode group, the sustain electrodes SU1 to SUn and the data electrodes D1 to Dm in the third SF and the subsequent SFs.

In the second SF and the subsequent SFs in the two-phase driving operation, it is preferable that an amount of electric charges generated by discharge is equal in the discharge cells belonging to the first discharge cell group (hereinafter referred to as first selected cells) and the discharge cells belonging to the second discharge cell group (hereinafter referred to as second selected cells) of the discharge cells in which the setup discharges have been generated in order to prevent crosstalk from occurring.

That is, the amount of electric charges generated by discharge in the first selected cells during application of the ramp waveform L4 is preferably equal to the sum of the amount of electric charges generated by discharge in the second selected cells during application of the ramp waveform L8 and the amount of electric charges generated by discharge in the second selected cells during application of the ramp waveform L9.

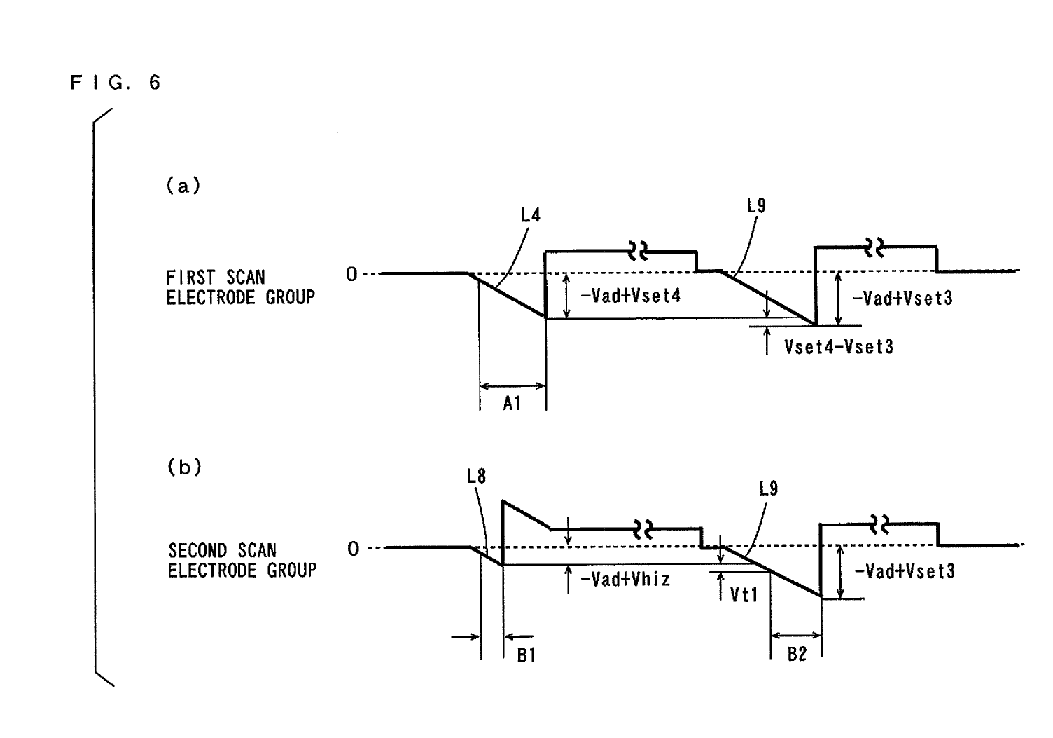

Here, description is made of the amount of electric charges generated by discharge in the first selected cells during the application of the ramp waveform L4 and the amounts of electric charges generated by discharge in the second selected cells during the application of the ramp waveforms L8, L9. FIG. 6 (a) shows a relationship between change in the potential of the first scan electrode group and the amount of electric charges generated by discharge in the first selected cells in the second SF, and FIG. 6 (b) shows a relationship between change in the potential of the second scan electrode group and the amount of electric charges generated by discharge in the second selected cells in the second SF.

When the ramp waveform L4 is applied to the first scan electrode group, the discharges are normally generated in the first selected cells in a period A1 from a time point where the potential of the first scan electrode group slightly drops below the ground potential to a time point where the potential of the first scan electrode group attains (−Vad+Vset4) as shown in FIG. 6 (a).

When the ramp waveform L9 is applied to the first scan electrode group, the potential of the first scan electrode group attains a given value that is slightly lower than (−Vad+Vset4) to generate the discharges in the first discharge cells. In the present embodiment, however, (−Vad+Vset3) is set substantially equal to the given value. Therefore, the discharges are not generated in the first discharge cells in this period.

Meanwhile, when the ramp waveform L8 is applied to the second scan electrode group, the discharges are normally generated in the second selected cells in a period B1 from a time point where the potential of the second scan electrode group slightly drops below the ground potential to a time point where the potential of the second scan electrode group attains (−Vad+Vhiz) as shown in FIG. 6 (b).

When the ramp waveform L9 is applied to the second scan electrode group, the discharges are normally generated in the second selected cells in a period B2 from a time point where the potential of the second scan electrode group slightly drops below (−Vad+Vhiz) to a time point where the potential of the second scan electrode group attains (−Vad+Vset3).

Here, a potential difference between (−Vad+Vhiz) and the potential of the second scan electrode group at the starting time point of the period B2 is Vt1 in FIG. 6 (b). In the present embodiment, a value of Vset3 is set such that the potential difference (Vset4−Vset3) in FIG. 6 (a) is equal to the potential difference Vt1 in FIG. 6 (b). In this case, the sum of the amount of electric charges generated by discharge in the period B1 and the amount of electric charges generated by discharge in the period B2 is equal to the amount of electric charges generated by discharge in the period A1.

In this manner, the ramp waveform L9 drops to the potential that is lower than the potential to which the ramp waveform L4 drops, so that the amount of electric charges generated by the setup discharge is equal in the first selected cells and the second selected cells in the second SF and the subsequent SFs. This prevents an occurrence of crosstalk.

In the first SF, both the ramp waveforms L2, L6 drop to the same potential (−Vad+Vset2), however, crosstalk is unlikely to occur because (−Vad+Vset2) is set sufficiently low.

(1-4) Configuration of the Scan Electrode Drive Circuit 53

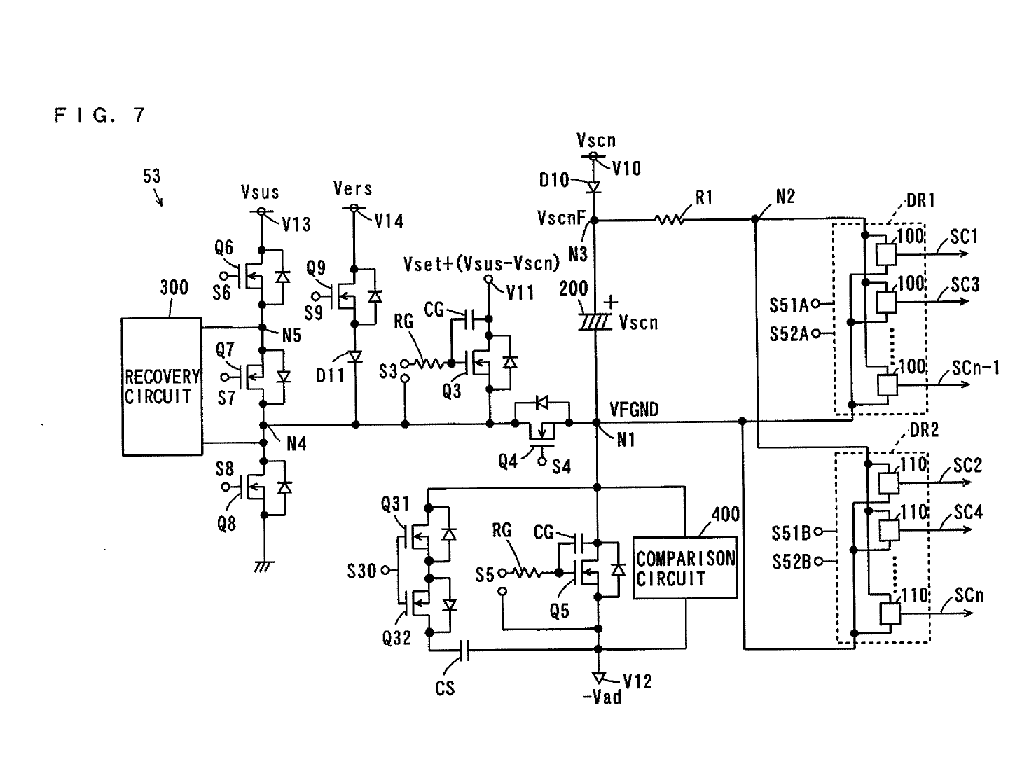

FIG. 7 is a circuit diagram showing the configuration of the scan electrode drive circuit 53.

The scan electrode drive circuit 53 includes a first drive circuit DR1, a second drive circuit DR2, a DC power supply 200, a recovery circuit 300, a comparison circuit 400, diodes D10, D11, n-channel field effect transistors (hereinafter abbreviated as transistors) Q3 to Q9, Q31, Q32 and a capacitor SC.

The first drive circuit DR1 includes a plurality of scan ICs 100. The scan ICs 100 are connected between a node N1 and a node N2 while being connected to the scan electrodes SC1, SC3, . . . , SCn−1, respectively, belonging to the first scan electrode group. The scan ICs 100 selectively connect the corresponding scan electrodes SC1, SC3, . . . , SCn−1, respectively, to the node N1 and the node N2.

Control signals S51A, S52A are applied to the first drive circuit DR1. The state of the scan ICs 100 is switched according to logic of the control signals S51A, S52A. Details of the scan ICs 100 will be described below.

The second drive circuit DR2 includes a plurality of scan ICs 110. The plurality of scan ICs 110 are connected between the node N1 and the node N2 while being connected to the scan electrodes SC2, SC4, . . . , SCn, respectively, belonging to the second scan electrode group. The scan ICs 110 selectively connect the corresponding scan electrodes SC2, SC4, . . . , SCn, respectively, to the node N1 and the node N2.

Control signals S51B, S52B are applied to the second drive circuit DR2. The state of the scan ICs 110 is switched according to logic of the control signals S51B, S52B. Details of the scan ICs 110 will be described below.

A power supply terminal V10 that receives the voltage Vscn is connected to a node N3 through the diode D10. The DC power supply 200 is connected between the node N1 and the node N3. The DC power supply 200 is composed of an electrolytic capacitor, and functions as a floating power supply that holds the voltage Vscn. A protective resistor R1 is connected between the node N2 and the node N3. Hereinafter, the potential of the node N1 is referred to as VFGND, and the potential of the node N3 is referred to as VscnF. The potential VscnF of the node N3 has a value obtained by adding the voltage Vscn to the potential VFGND of the node N1. That is, VscnF=VFGND+Vscn.

The transistor Q3 is connected between a power supply terminal V11 that receives a voltage (Vset+(Vsus−Vscn)) and a node N4, and a control signal S3 is applied to a gate. The transistor Q4 is connected between the node N1 and the node N4, and a control signal S4 is applied to a gate.

The transistor Q5 is connected between the node N1 and a power supply terminal V12 that receives the negative voltage (−Vad), and a control signal S5 is applied to a gate. The control signal S4 is an inverted signal of the control signal S5. The transistors Q31, Q32 and the capacitor CS are connected in series between the node N1 and the power supply terminal V12, and the comparison circuit 400 is connected between the node N1 and the power supply terminal V12. The transistors Q31, Q32 constitute a bi-directional switching element, and a control signal S30 is applied to a gate. Details of the comparison circuit 400 will be described below.

A gate resistor RG and a capacitor CG are connected to the transistor Q3, and a gate resistor RG and a capacitor CG are connected to the transistor Q5. A gate resistor and a capacitor, not shown, are also connected to the transistor Q6.

The transistor Q6 is connected between a power supply terminal V13 that receives the voltage Vsus and a node N5. A control signal S6 is applied to a base of the transistor Q6. The transistor Q7 is connected between the node N4 and the node N5. A control signal S7 is applied to a gate of the transistor Q7. The transistor Q8 is connected between the node N4 and a ground terminal, and a control signal S8 is applied to a base.

The transistor Q9 and the diode D11 are connected between a power supply terminal V14 that receives a voltage Vers and the node N4. A control signal S9 is applied to a base of the transistor Q9.

The recovery circuit 300 is connected between the node N4 and the node N5. The recovery circuit 300 recovers the electric charges from the plurality of discharge cells and stores the recovered electric charges, and provides the stored electric charges to the plurality of discharge cells in the sustain period.

(1-5) Details of the Scan ICs

Next, description is made of details of the scan ICs 100, 110. As described above, the state of the scan ICs 100 is switched according to the logic of the control signals S51A, S52A, and the state of the scan ICs 110 is switched according to the logic of the control signals S51B, S52B.

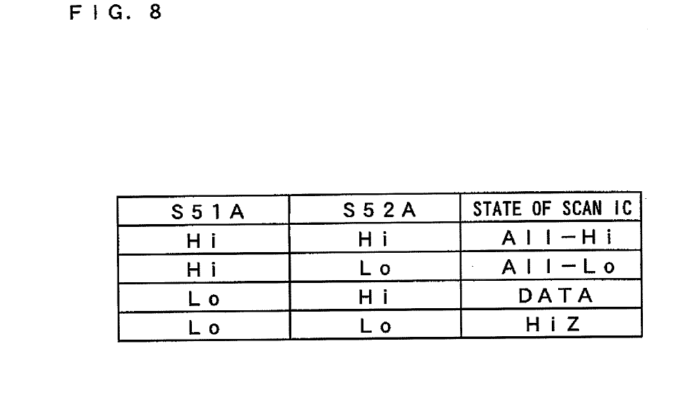

FIG. 8 is a diagram showing correspondences among the respective logic of the control signals S51A, S52A and the states of the scan ICs 100. The correspondences among the respective logic of the control signals S51B, S52B and the states of the scan ICs 110 are the same as the correspondences among the respective logic of the control signals S51A, S52A and the states of the scan IC 100.

As shown in FIG. 8, when both the control signals S51A, S52A are at a high level (Hi), each scan IC 100 enters an “All-Hi” (all-high) state. All the scan ICs 100 connect the corresponding scan electrodes to the node N2 in the “All-Hi” state. That is, the potentials of the scan electrodes SC1, SC3, . . . , SCn−1 are equal to the potentials of the node N2 and the node N3.

When the control signal S51A is at a high level and the control signal S52A is at a low level (Lo), each scan IC 100 enters an “All-Lo” (all-low) state. All the scan ICs 100 connect the corresponding scan electrodes to the node N1 in the “All-Lo” state. That is, the potentials of the scan electrodes SC1, SC3, . . . , SCn−1 are equal to the potential of the node N1.

When the control signal S51A is at a low level and the control signal S52A is at a high level, each scan IC 100 enters a “DATA” (data) state. The scan ICs 100 sequentially connect the corresponding scan electrodes to the node N1 in the “DATA” state. In this case, the write pulse is sequentially applied to the scan electrodes SC1, SC3, . . . , SCn−1 in the write period.

When both the control signals S51A, S52A are at a low level, each scan IC 100 enters a “HiZ” (high impedance) state. All the scan ICs 100 cut off the corresponding scan electrodes from the node N1 and the node N2 in the “HiZ” state.

(1-6) Operation of the Scan Electrode Drive Circuit

Next, description is made of operation of the scan electrode drive circuit 53. First, the operation of the scan electrode drive circuit 53 in the two-phase driving operation is described, because the operation of the scan electrode drive circuit 53 in the one-phase driving operation can be easily described based on the operation of the scan electrode drive circuit 53 in the two-phase driving operation.

(1-6-1) The Operation of the Scan Electrode Drive Circuit in the Two-Phase Driving Operation

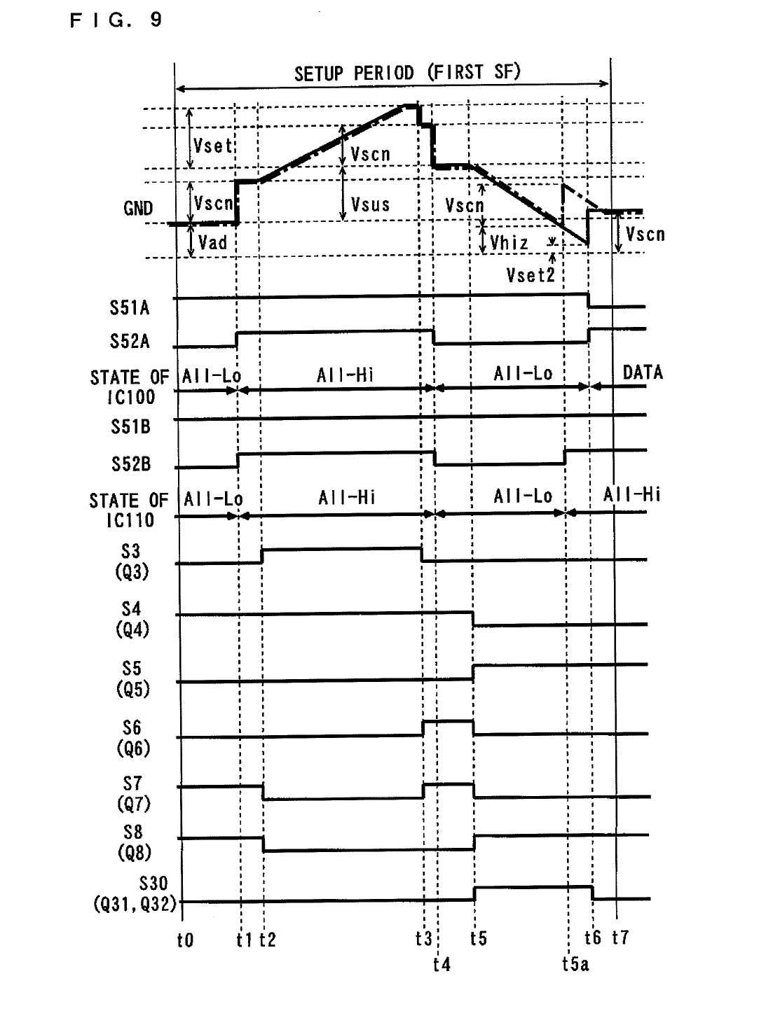

FIGS. 9 to 12 are timing charts of the control signals for explaining the operation of the scan electrode drive circuit 53 in the two-phase driving operation.

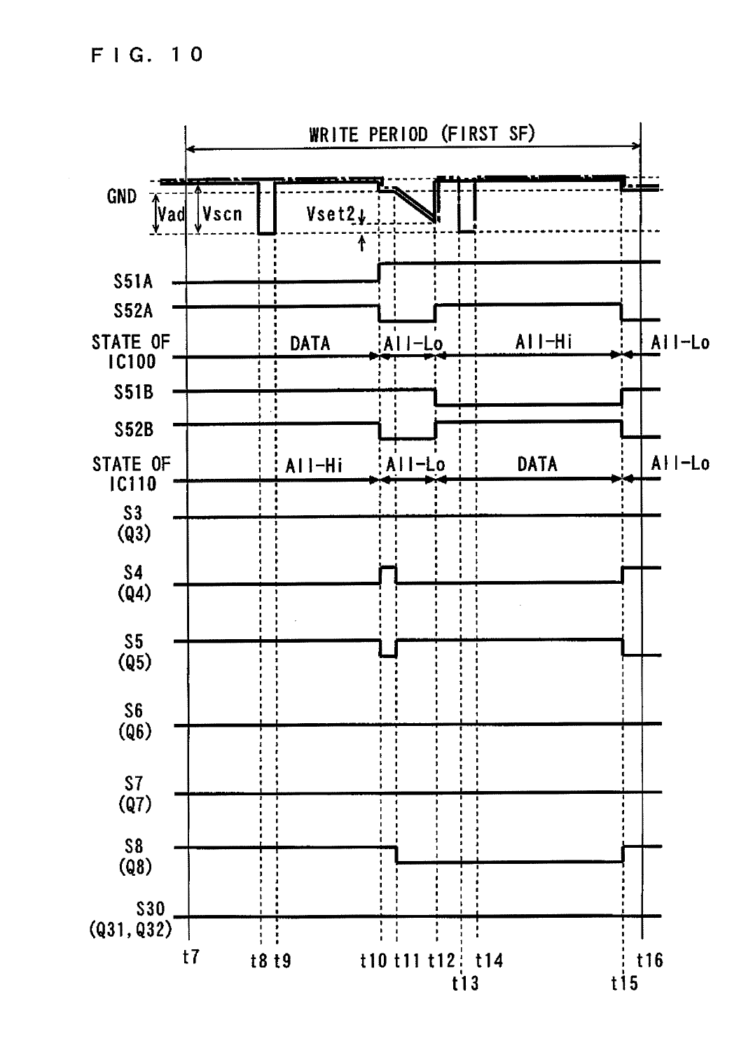

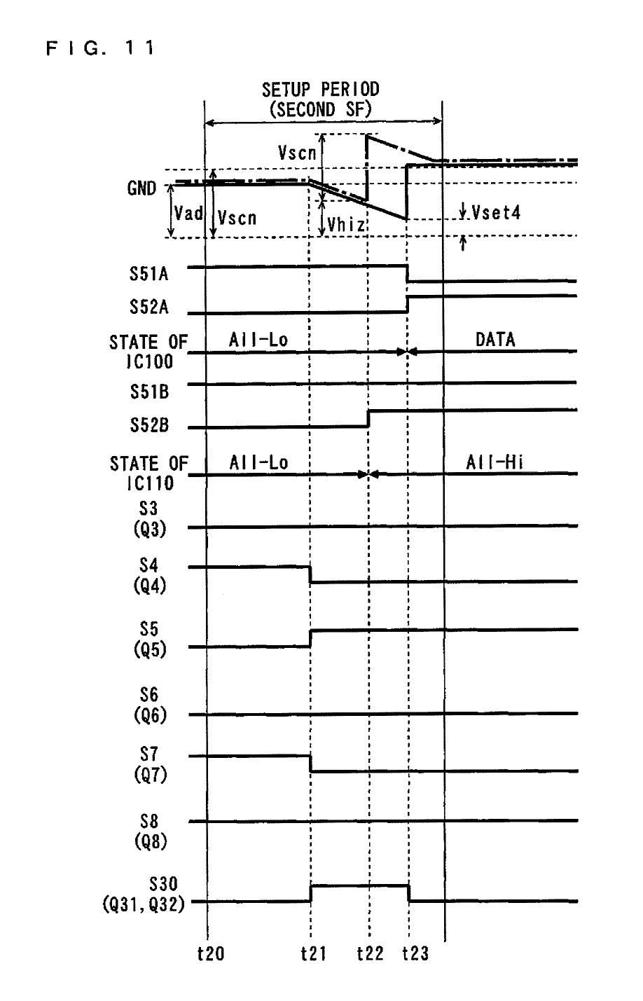

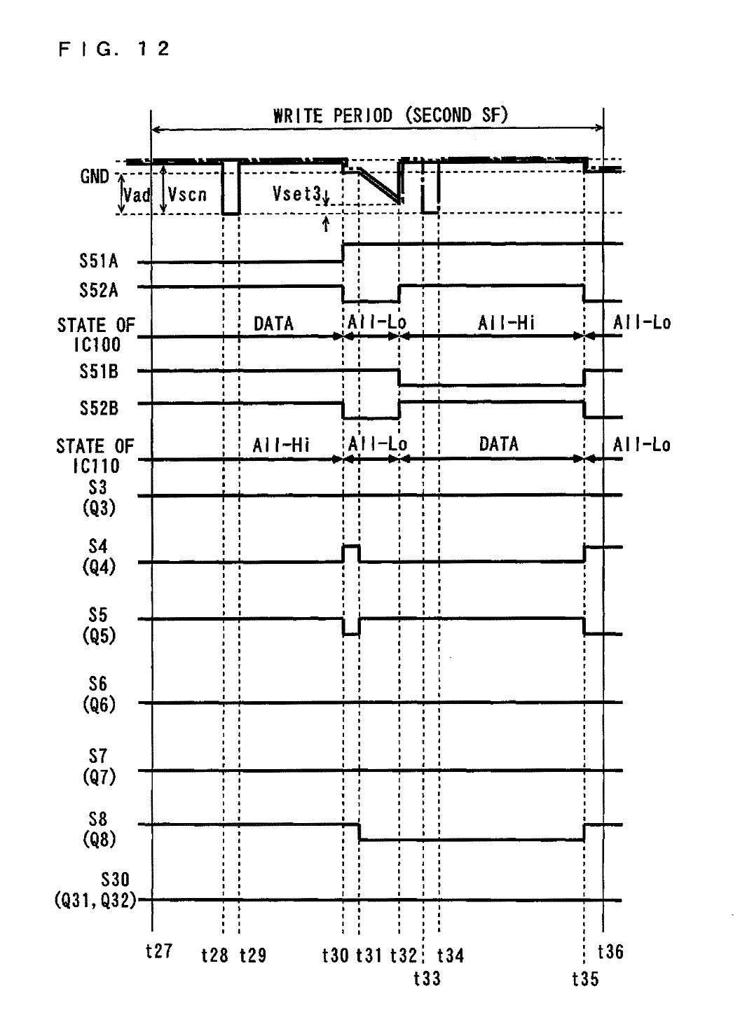

FIG. 9 is a timing chart of the control signals in the setup period of the first SF, FIG. 10 is a timing chart of the control signals in the write period of the first SF, FIG. 11 is a timing chart of the control signals in the setup period of the second SF, and FIG. 12 is a timing chart of the control signals in the write period of the second SF. FIGS. 9 to 12 show states of the control signals S3 to S8, S30, S51A, S52A, S51B, S52B and the scan ICs 100, ICs 110 (abbreviated as ICs 100 and ICs 110 in the drawings). Change of the potential of the scan electrode SC1 is indicated by the solid line, and change of the potential of the scan electrode SC2 is indicated by the one-dot and dash line in the top stages of FIGS. 9 to 12.

(1-6-1-1) The First SF

At a starting time point t0 of the setup period of the first SF of FIG. 9, the control signals S51A, S51B are at a high level, and the control signals S52A, S52B are at a low level. This causes each of the scan ICs 100, 110 to be in the “All-Lo” state. The control signals S3, S5, S6, S30 are at a low level, and the control signals S4, S7, S8 are at a high level. This causes the transistors Q3, Q5, Q6, Q31, Q32 to be turned off and the transistors Q4, Q7, Q8 to be turned on.

Accordingly, the node N1 attains the ground potential (0 V) and the potential VscnF of the node N3 attains Vscn. Since each of the scan ICs 100, 110 is in the “All-Lo” state, the potentials of the scan electrodes SC1, SC2 attain the ground potential.

The control signals S52A, S52B attain a high level at a time point t1. This causes each of the scan ICs 100, 110 to enter the “All-Hi” state. Thus, the potentials of the scan electrodes SC1, SC2 rise to Vscn.

The control signal S3 attains a high level and the control signals S7, S8 attain a low level at a time point t2. This causes the transistor Q3 to be turned on and the transistors Q7, Q8 to be turned off. Thus, an RC integration circuit constituted by the gate resistor RG and the capacitor CG connected to the transistor Q3 causes the potential VFGND of the node N1 to gradually rise to (Vset+(Vsus−Vscn)). The potential VscnF of the node N3 gradually rises to (Vsus+Vset). At this time, since the scan ICs 100, 110 are in the “All-Hi” state, the potentials of the scan electrodes SC1, SC2 gradually rise to (Vsus+Vset).

At a time point t3, the control signal S3 attains a low level and the control signals S6, S7 attain a high level. This causes the transistor Q3 to be turned off and the transistors Q6, Q7 to be turned on. As a result, the potential VFGND of the node N1 drops to Vsus and the potential VscnF of the node N3 drops to (Vscn+Vsus). At this time, since the scan ICs 100, 110 are in the “All-Hi” state, the potentials of the scan electrodes SC1, SC2 drop to (Vscn+Vsus).

At a time point t4, the control signals S52A, S52B attain a low level. This causes the scan ICs 100, 110 to be in the “All-Lo” state. At this time, since the potential of the potential VFGND of the node N1 attains Vsus, the potentials of the scan electrodes SC1, SC2 drop to Vsus.

At a time point t5, the control signals S4, S6, S7 attain a low level, and the control signals S5, S8, S30 attain a high level. This causes the transistors Q4, Q6, Q7 to be turned off, and the transistors Q5, Q8, Q31, Q32 to be turned on. As a result, an RC integration circuit constituted by the gate resistor RG and the capacitor CG connected to the transistor Q5 causes the potential VFGND of the node N1 to gradually drop toward (−Vad). At this time, since the scan ICs 100, 110 are in the “All-Lo” state, the potentials of the scan electrodes SC1, SC2 gradually drop toward (−Vad).

The control signal S52B attains a high level at a time point t5a where the potentials of the scan electrodes SC1, SC2 (the potential of the node N1) attain (−Vad+Vhiz). Thus, the scan ICs 110 enter the “All-Hi” state, and the potential of the scan electrode SC2 rises by Vscn. Then, the potential of the scan electrode SC2 gradually drops toward (−Vad+Vscn).

When the node N1 is connected to the power supply terminal V10 through the second drive circuit DR2 at the time point t5a, a current instantaneously flows from the node N1 to the power supply terminal V12 through the transistor Q5. This causes the potential of the node N1 to rapidly drop to −Vad. Therefore, the transistors Q31, Q32 are maintained in an ON state, and the current flows from the node N1 to the power supply terminal V12 through the capacitor CS in a period between the time points t5 and t6 in the present embodiment. As a result, the potential of the node N1 can be prevented from rapidly dropping because of the current flowing into the power supply terminal V12 through the transistor Q5.

The control signal S52B is switched by the comparison circuit 400 of FIG. 7 at the time point t5a. The control signals S52A, S52B are switched by the comparison circuit 400 also at time points t6, t12, t22, t23, t32, described below. Details of the comparison circuit 400 will be described below.

The control signal S51A attains a low level and the control signal S52A attains a high level at the time point t6 where the potential of the scan electrode SC1 (the potential of the node N1) attains (−Vad+Vset2). This causes the scan ICs 100 to be in the “DATA” state. As a result, the potential of the scan electrodes SC1 rises to (−Vad+Vscn).

At the time point t6, the control signal S30 attains a low level, and the transistors Q31, Q32 are turned off. Note that the transistors Q31, Q32 may be maintained in an ON state until a time point that is later than the time point t6 in order to more reliably prevent the potential of the node N1 from rapidly dropping.

As shown in FIG. 10, the scan ICs 100 are maintained in the “DATA” state in the first half of the write period (a period between time points t7 and t10) in the first SF. Thus, the scan electrodes SC1, SC3, . . . , SCn−1 are sequentially connected to the node N1. At this time, the potential VFGND of the node N1 attains (−Vad). Therefore, the potentials of the scan electrodes SC1, SC3, . . . , SCn−1 sequentially drop to (−Vad). In FIG. 10, the potential of the scan electrode SC1 drops to (−Vad) in a period between time points t8 and t9.

On the other hand, the scan ICs 110 are maintained in the “All-Hi” state. Thus, the potential of the scan electrode SC2 is maintained at (−Vad+Vscn).

The control signal S4 attains a high level and the control signal S5 attains a low level at the time point t10. This causes the transistor Q4 to be turned on and the transistor Q5 to be turned off. As a result, the potential VFGND of the node N1 rises to the ground potential, and the potential VscnF of the node N3 rises to Vscn. The control signal S51A attains a high level, and the control signals S52A, S52B attain a low level. This causes the scan ICs 100, 110 to be in the “All-Lo” state. Accordingly, the potentials of the scan electrodes SC1, SC2 drop to the ground potential.

The control signal S4 attains a low level and the control signal S5 attains a high level at a time point t11. This causes the transistor Q4 to be turned off and the transistor Q5 to be turned on. As a result, the RC integration circuit constituted by the gate resistor RG and the capacitor CG connected to the transistor Q5 causes the potential VFGND of the node N1 to gradually drop toward (−Vad). The potential of the potential VscnF of the node N3 gradually drops toward (−Vad+Vscn). At this time, since the scan ICs 100, 110 are in the “All-Lo” state, the potentials of the scan electrodes SC1, SC2 gradually drop toward (−Vad).

The control signal S52A attains a high level at the time point t12 where the potentials of the scan electrodes SC1, SC2 (the potential of the node N1) attains (−Vad+Vset2). This causes the scan ICs 100 to be in the “All-Hi” state. The control signal S51B attains a low level, and the control signal S52B attains a high level. This causes the scan ICs 110 to be in the “DATA” state. At this time, the potential VscnF of the node N3 attains (−Vad+Vscn). Accordingly, the potentials of the scan electrodes SC1, SC2 rise to (−Vad+Vscn).

The scan ICs 100 are maintained in the “All-Hi” state in the second half of the write period (a period between the time points t12 and t15) in the first SF. Accordingly, the potential of the scan electrode SC1 is maintained at (−Vad+Vscn).

On the other hand, the scan ICs 110 are maintained in the “DATA” state. Thus, the scan electrodes SC2, SC4, . . . , SCn are sequentially connected to the node N1. At this time, the potential VFGND of the node N1 attains (−Vad). Therefore, the potentials of the scan electrodes SC2, SC4, . . . , SCn sequentially drop to (−Vad). In FIG. 10, the potential of the scan electrode SC2 drops to (−Vad) in a period between time points t13 and t14.

(1-6-1-2) The Second Sub-Field and the Subsequent Sub-Fields

As shown in FIG. 11, at a starting time point t20 of the setup period of the second SF, the control signals S51A, S51B are at a high level, and the control signals S52A, S52B are at a low level. This causes each of the scan ICs 100, 110 to be in the “All-Lo” state. The control signals S3, S5, S6, S30 are at a low level, and the control signals S4, S7, S8 are at a high level. This causes the transistors Q3, Q5, Q6, Q31, Q32 to be turned off and the transistors Q4, Q7, Q8 to be turned on.

Thus, the potential VFGND of the node N1 attains the ground potential and the potential VscnF of the node N3 attains Vscn. Since the scan ICs 100, 110 are in the “All-Lo” state, the potentials of the scan electrodes SC1, SC2 attain the ground potential.

The control signals S4, S7 attain a low level and the control signals S5, S30 attain a high level at a time point t21. Thus, the transistors Q4, Q7 are turned off and the transistors Q5, Q31, Q32 are turned on. As a result, the RC integration circuit constituted by the gate resistor RG and the capacitor CG connected to the transistor Q5 causes the potential VFGND of the node N1 to gradually drop toward (−Vad). At this time, since the scan ICs 100, 110 are in the “All-Lo” state, the potentials of the scan electrodes SC1, SC2 gradually drop toward (−Vad).

The control signal S52B attains a high level at the time point t22 where the potentials of the scan electrodes SC1, SC2 (the potential of the node N1) attain (−Vad+Vhiz). Thus, the scan IC 110 enters the “All-Hi” state, and the potential of the scan electrode SC2 rises by Vscn. Then, the potential of the scan electrode SC2 gradually drops toward (−Vad+Vscn).

When the node N1 is connected to the power supply terminal V10 through the second drive circuit DR2 at the time point t22 similarly to the time point 5a, the current instantaneously flows from the node N1 to the power supply terminal V12 through the transistor Q5. This causes the potential of the node N1 to rapidly drop to −Vad. Therefore, the transistors Q31, Q32 are maintained in an ON state, and the current flows from the node N1 to the power supply terminal V12 through the capacitor CS in a period between the time points t21 and t23 in the present embodiment. As a result, the potential of the node N1 can be prevented from rapidly dropping because of the current flowing into the power supply terminal V12 through the transistor Q5.

The control signal 551A attains a low level and the control signal S52A attains a high level at the time point t23 where the potential of the scan electrode SC1 (the potential of the node N1) attains (−Vad+Vset4). This causes the scan ICs 100 to be in the “DATA” state. As a result, the potential of the scan electrode SC1 rises to (−Vad+Vscn).

The control signal S30 attains a low level, and the transistors Q31, Q32 are turned off at the time point t23. Note that the transistors Q31, Q32 may be maintained in an ON state until a time point that is later than the time point t23 in order to more reliably prevent the potential of the node N1 from rapidly dropping.

As shown in FIG. 12, in the write period of the second SF, each of the control signals changes in a period between time points t27 and t31 in the same manner as in a period between the time points t7 and t11 of FIG. 10. Note that in FIG. 12, the potential of the scan electrode SC1 drops to (−Vad) in a period between time points t28 and t29.

The control signal S52A attains a high level at the time point t32 where the potentials of the scan electrodes SC1, SC2 (the potential of the node N1) attain (−Vad+Vset3). This causes the scan ICs 100 to be in the “All-Hi” state. The control signal S51B attains a low level, and the control signal S52B attains a high level. This causes the scan ICs 110 to be in the “DATA” state. At this time, the potential VscnF of the node N3 attains (−Vad+Vscn). Accordingly, the potentials of the scan electrodes SC1, SC2 rise to (−Vad+Vscn).

Each of the control signals changes in a period between the time points t32 and t35 in the same manner as in the period between the time points t12 and t15 of FIG. 10. In FIG. 12, the potential of the scan electrode SC2 drops to (−Vad) in a period between time points t33 and t34.

Each of the control signals changes in the third SF and the subsequent SFs in the same manner as in the second SF.

(1-6-2) The Operation of the Scan Electrode Drive Circuit in the One-Phase Driving Operation

Next, description is made of the operation of the scan electrode drive circuit 53 in the one-phase driving operation.

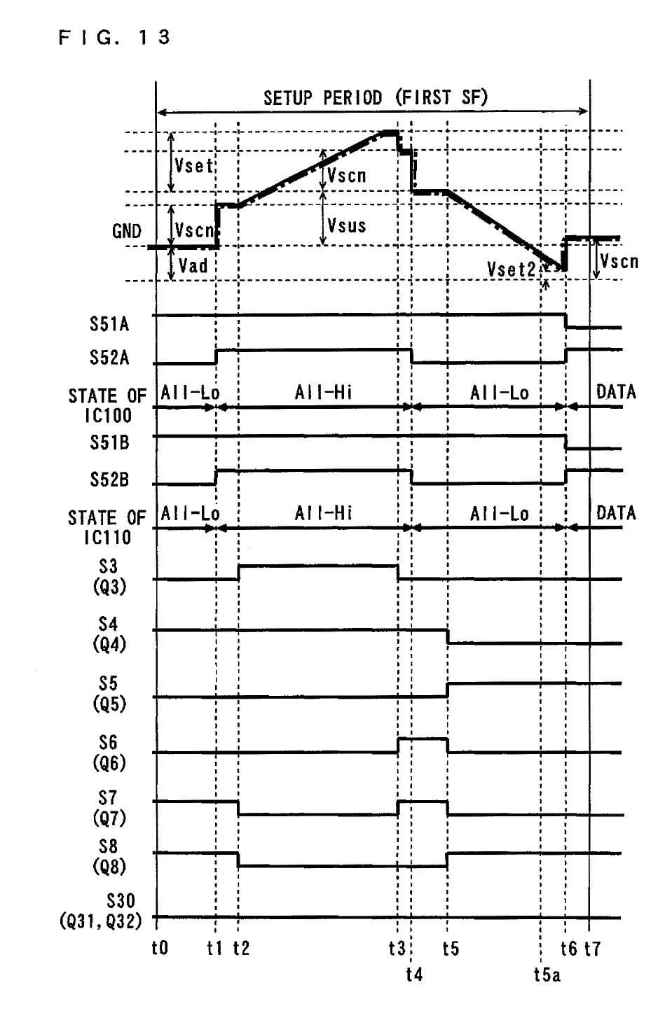

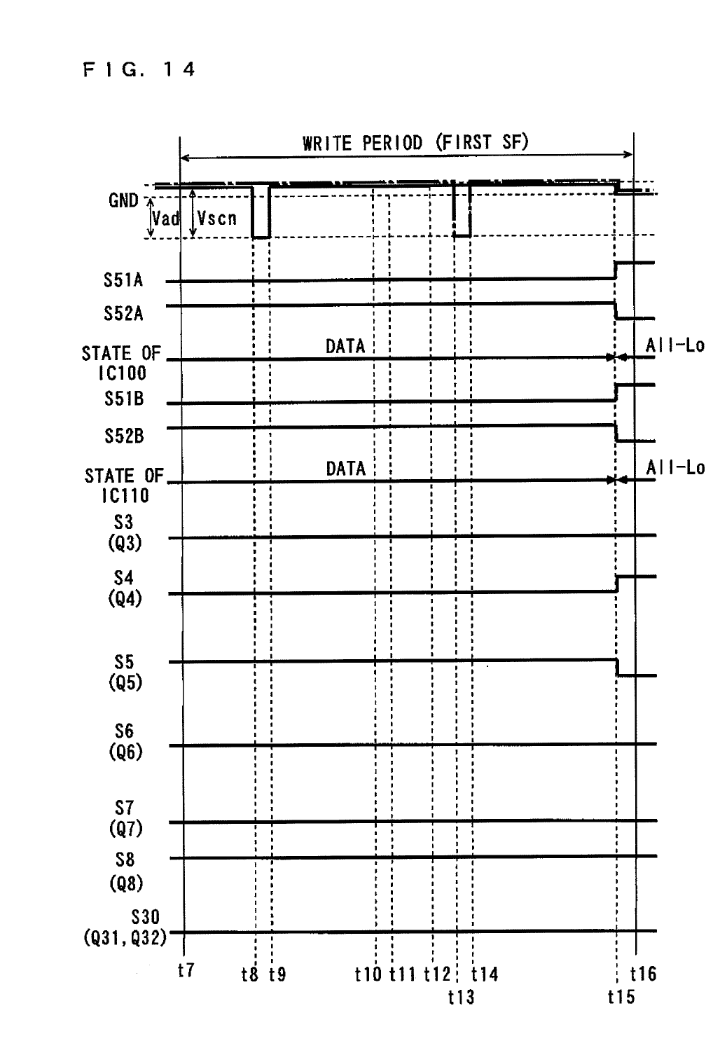

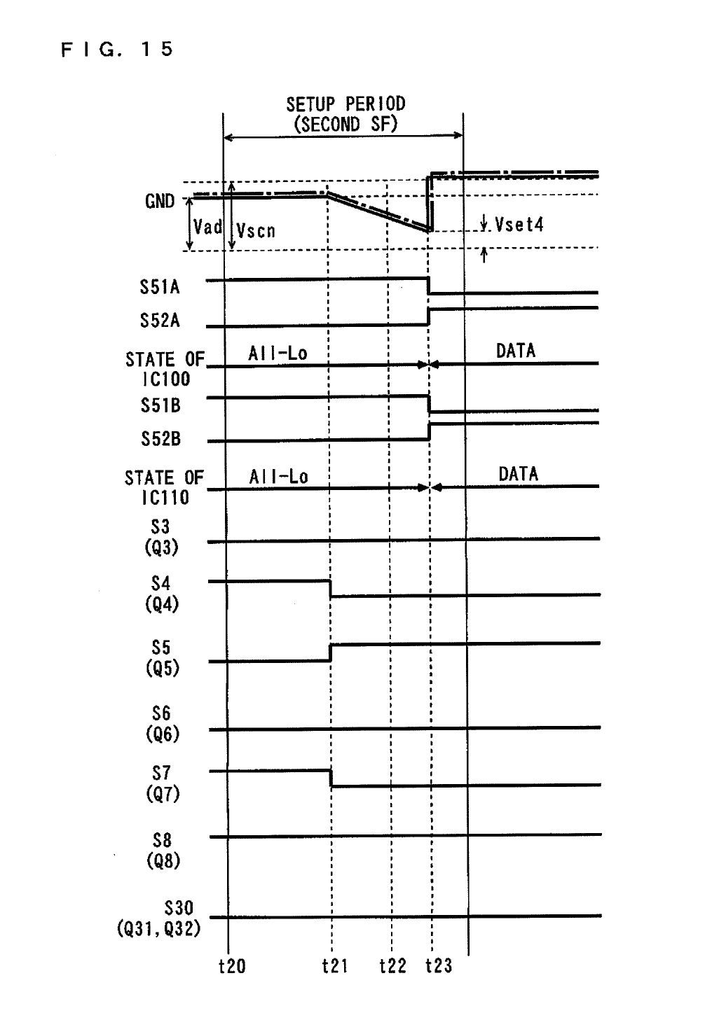

FIGS. 13 to 15 are timing charts of the control signals for explaining the operation of the scan electrode drive circuit 53 in the one-phase driving operation. FIG. 13 is a timing chart of the control signals in the setup period of the first SF, FIG. 14 is a timing chart of the control signals in the write period of the first SF, and FIG. 15 is a timing chart of the control signals in the setup period of the second SF. FIGS. 13 to 15 show states of the control signals S3 to S8, S30, S51A, S52A, S51B, S52B and the scan ICs 100, ICs 110 (abbreviated as the ICs 100 and the ICs 110 in the drawings).

The timing charts in FIGS. 13 to 15 are different from those in FIGS. 9 to 12 in the following points.

As shown in FIG. 13, the scan ICs 110 are maintained in the “All-Lo” state in a period between the time points t5a and t6 in the one-phase driving operation of the scan electrode drive circuit 53. At the time point t6, the control signal S51B attains a low level, and the control signal S52B attains a high level. This causes the scan ICs 110 to be in the “DATA” state.

That is, the scan ICs 100 and the scan ICs 110 are in the same state in the setup period. Accordingly, the potential of the scan electrode SC1 and the potential of the scan electrode SC2 change in the same manner.

As shown in FIG. 14, the control signals S51A, S51B are maintained at a low level, and the control signals S52A, S52B are maintained at a high level in a period between the time points t7 and t15. Thus, the scan ICs 100, 110 are maintained in the “DATA” state. The control signal S4 is maintained at a low level, and the control signals S5, S8 are maintained at a high level in a period between the time points t10 and t12. Accordingly, the transistor Q4 is maintained in an OFF state and the transistors Q5, S8 are maintained in an ON state.

In this case, the scan electrodes SC1, SC2, . . . , SCn−1, SCn are sequentially connected to the node N1, and the potentials of the scan electrodes SC1, SC2, . . . , SCn−1, SCn sequentially drop to (−Vad).

As shown in FIG. 15, the scan ICs 110 are maintained in the “All-Lo” state in a period between the time points t22 and t23. At the time point t23, the control signal S51B attains a low level and the control signal S52B attains a high level. This causes the scan ICs 110 to be in the “DATA” state. That is, the scan ICs 110 and the scan ICs 100 are in the same state in a period between the time points t20 and t23. Accordingly, the potential of the scan electrode SC1 and the potential of the scan electrode SC2 change in the same manner.

The control signal S30 is maintained at a low level, and the transistors Q31, Q32 are maintained in an OFF state throughout all the periods in the one-phase driving operation.

(1-7) Comparison Circuit

(1-7-1) Configuration

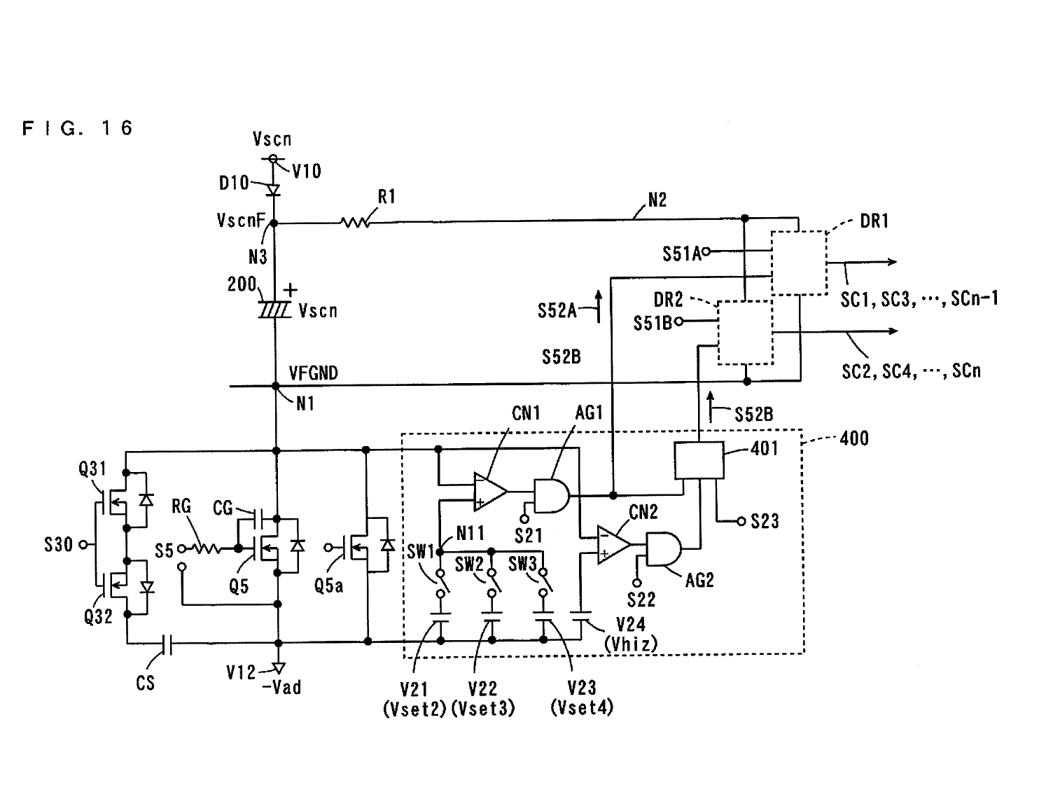

Next, description is made of details of the comparison circuit 400. FIG. 16 is a circuit diagram specifically showing the configuration of the comparison circuit 400 and its periphery.

As shown in FIG. 16, the comparison circuit 400 includes comparators CN1, CN2, AND gate circuits AG1, AG2, power supplies V21 to V24, switches SW1 to SW3 and a selector 401.

A negative-side input terminal of the comparator CN1 is connected to the node N1. A positive-side input terminal of the comparator CN1 is connected to a node N11. The power supplies V21, V22, V23 are connected in parallel through the switch circuits SW1, SW2, SW3, respectively, between the node N11 and the power supply terminal V12. The power supply V21 holds the voltage Vset2, the power supply V22 holds the voltage Vset3, and the power supply V23 holds the voltage Vset4. Note that Vset2 is 6 V, Vset3 is 8 V, and Vset4 is 10 V, for example.

An output terminal of the comparator CN1 is connected to one input terminal of the AND gate circuit AG1. A control signal S21 is applied to the other input terminal of the AND gate circuit AG1.

An output terminal of the AND gate circuit AG1 is connected to the first drive circuit DR1 and an input terminal of the selector 401. An output signal from the AND gate circuit AG1 is applied to the first drive circuit DR1 as the control signal S52A at particular timings.

A negative-side input terminal of the comparator CN2 is connected to the node N1. A positive-side input terminal of the comparator CN2 is connected to the power supply terminal V12 through the power supply V24. The power supply V24 holds the voltage Vhiz. This causes the potential of the positive-side input terminal of the comparator CN2 to be held at (−Vad+Vhiz). Note that Vhiz is 70 V, for example. An output terminal of the comparator CN2 is connected to one input terminal of the AND gate circuit AG2. A control signal S22 is applied to the other input terminal of the AND gate circuit AG2.

An output terminal of the AND gate circuit AG2 is connected to an input terminal of the selector 401. A control signal S23 is applied to an input terminal of the selector 401. An output terminal of the selector 401 is connected to the second drive circuit DR2. Any of an output signal from the AND gate circuit AG1, an output signal from the AND gate circuit AG2 and the control signal S23 is selectively applied to the second drive circuit DR2 as the control signal S52B by the selector 401 at particular timings.

In the example of FIG. 16, an n-channel field effect transistor (hereinafter abbreviated as a transistor) Q5a is connected between the node N1 and the power supply terminal V12. The transistor Q5a is turned on while the transistor Q5 is turned off, thereby causing the potential of the node N1 to instantaneously drop to −Vad.

(1-7-2) Operation

Next, description is made of the operation of the comparison circuit 400 of FIG. 16. First, description is made of the operation of the comparison circuit 400 in the period between the time points t5 and t6 of FIG. 9. In this period, the output signals from the comparison circuit 400 are applied to the first and second drive circuits DR1, DR2 as the control signals S52A, S52B.

Note that the switch SW1 is turned on, and the potential of the positive-side input terminal of the comparator CN1 is maintained at (−Vad+Vset2) in this period. The control signals S21, S22 are maintained at a high level. The selector 401 applies the output signal from the AND gate circuit AG2 to the second drive circuit DR2 as the control signal S52B.

The potential of the node N1 is higher than (−Vad+Vhiz) in a period between the time points t5 and t5a. Therefore, the potential of the negative-side input terminal of the comparator CN1 is higher than the potential of the positive-side input terminal thereof, and the potential of the output terminal thereof attains a low level. Accordingly, the potential of the output terminal of the AND gate circuit AG1 attains a low level, and the control signal S52A attains a low level.

The potential of the negative-side input terminal of the comparator CN2 is higher than the potential of the positive-side input terminal thereof, and the potential of the output terminal thereof attains a low level. This causes the potential of the output terminal of the AND gate circuit AG2 to attain a low level. Therefore, the control signal S52B attains a low level.

In this case, the scan ICs 100, 110 are maintained in the “All-Lo” state, and the potentials of the scan electrodes SC1, SC2 gradually drop.

When the potential of the node N1 attains (−Vad+Vhiz) at the time point t5a, the potential of the output terminal of the comparator CN2 attains a high level. Accordingly, the potential of the output terminal of the AND gate circuit AG2 attains a high level, and the control signal S52B attains a high level. In this case, the scan ICs 110 enter the “All-Hi” state, and the potential of the scan electrode SC2 rises by Vscn.

Then, when the potential of the node N1 attains (−Vad+Vset2) at the time point t6, the potential of the output terminal of the comparator CN1 attains a high level. Thus, the potential of the output terminal of the AND gate circuit AG1 attains a high level, and the control signal S52A attains a high level. In this case, the scan ICs 100 enter the “DATA” state, and the potential of the scan electrode SC1 rises to (−Vad+Vscn).

Next, description is made of the operation of the comparison circuit 400 in a period between the time points t11 and t12 of FIG. 10. In this period, the output signals from the comparison circuit 400 are applied to the first and second drive circuits DR1, DR2 as the control signals S52A, S52B.

The switch SW1 is turned on, and the potential of the positive-side input terminal of the comparator CN1 is maintained at (−Vad+Vset2) in this period. The control signals S21, S22 are maintained at a high level. The selector 401 applies the output signal from the AND gate circuit AG1 to the second drive circuit DR2 as the control signal S52B.

The potential of the node N1 is higher than (−Vad+Vset2) in the period between the time points t11 and t12. Therefore, the potential of the negative-side input terminal of the comparator CN1 is higher than the potential of the positive-side input terminal thereof, and the potential of the output terminal thereof attains a low level. Accordingly, the potential of the output terminal of the AND gate circuit AG1 attains a low level, and the control signals S52A, S52B attain a low level.

In this case, the scan ICs 100, 110 are maintained in the “All-Lo” state, and the potentials of the scan electrodes SC1, SC2 gradually drop.

When the potential of the node N1 attains (−Vad+Vset2) at the time point t12, the potential of the output terminal of the comparator CN1 attains a high level. Therefore, the potential of the output terminal of the AND gate circuit AG1 attains a high level, and the control signals S52A, S52B attain a high level.

In this case, the scan ICs 100 enter the “All-Hi” state, and the scan ICs 110 enter the “DATA” state. This causes the potentials of the scan electrodes SC1, SC2 to rise to (−Vad+Vscn).

Next, description is made of the operation of the comparison circuit 400 in the period between the time points t21 and t23 of FIG. 11. In this period, the output signals from the comparison circuit 400 are applied to the first and second drive circuits DR1, DR2 as the control signals S52A, S51B, S52B.

Note that the switch SW3 is turned on, and the potential of the positive-side input terminal of the comparator CN1 is maintained at (−Vad+Vset4) in this period. The control signals S21, S22 are maintained at a high level. The selector 401 applies the output signal from the AND gate circuit AG2 to the second drive circuit DR2 as the control signal S52B.

The scan circuit 400 operates in the period between the time points t21 and t23 in the same manner as in the period between the time points t5 and t6 of FIG. 9.

When the potential of the node N1 attains (−Vad+Vset4) at the time point t23, the potential of the output terminal of the comparator CN1 attains a high level. Thus, the potential of the output terminal of the AND gate circuit AG1 attains a high level, and the control signal S52A attains a high level. In this case, the scan ICs 100 enter the “DATA” state, and the potential of the scan electrode SC1 rises to (−Vad+Vscn).

Next, description is made of the operation of the comparison circuit 400 in a period between the time points t31 and t32 of FIG. 12. In this period, the output signals from the comparison circuit 400 are applied to the first and second drive circuits DR1, DR2 as the control signals S52A, S51B, S52B.

Note that the switch SW2 is turned on, and the potential of the positive-side input terminal of the comparator CN1 is maintained at (−Vad+Vset3) in this period. The control signals S21, S22 are maintained at a high level. The selector 401 applies the output signal from the AND gate circuit AG1 to the second drive circuit DR2 as the control signal S52B.

The potential of the node N1 is higher than (−Vad+Vset3) in the period between the time points t31 and t32. In this case, the potential of the negative-side input terminal of the comparator CN1 is higher than the potential of the positive-side input terminal thereof, and the potential of the output terminal thereof attains a low level. Accordingly, the potential of the output terminal of the AND gate circuit AG1 attains a low level, and the control signals S52A, S52B attain a low level.

In this case, the scan ICs 100, 110 are maintained in the “All-Lo” state, and the potentials of the scan electrodes SC1, SC2 gradually drop.

When the potential of the node N1 attains (−Vad+Vset3) at the time point t32, the potential of the output terminal of the comparator CN1 attains a high level. Therefore, the potential of the output terminal of the AND gate circuit AG1 attains a high level, and the control signals S52A, S52B attain a high level.

In this case, the scan ICs 100 enter the “All-Hi” state, and the scan ICs 110 enter the “DATA” state. Accordingly, the potentials of the scan electrodes SC1, SC2 rise to (−Vad+Vscn).

Next, description is made of the operation of the comparison circuit 400 in the period between the time points t5 and t6 of FIG. 13 and the period between the time points t21 and t23 of FIG. 15 by referring to differences from the operation of the comparison circuit 400 in the period between the time points t5 and t6 of FIG. 9 and the period between the time points t21 and t23 of FIG. 11.

In these periods, the selector 401 applies the output signal from the AND gate circuit AG1 to the second drive circuit DR2 as the control signal S52B, and the state of the scan ICs 100 and the state of the scan ICs 110 change in the same manner. Accordingly, the potential of the scan electrode SC1 and the potential of the scan electrode SC2 change in the same manner.

In this manner, the states of the scan ICs 100, 110 are switched by the comparison circuit 400 at suitable timings according to the change in the potentials of the scan electrodes SC1, SC2 at the time of application of the ramp waveforms to the scan electrodes SC1, SC2. Accordingly, the potentials of the scan electrodes SC1, SC2 can be accurately controlled.

(1-8) Selection of the One-Phase Driving Operation and the Two-Phase Driving Operation

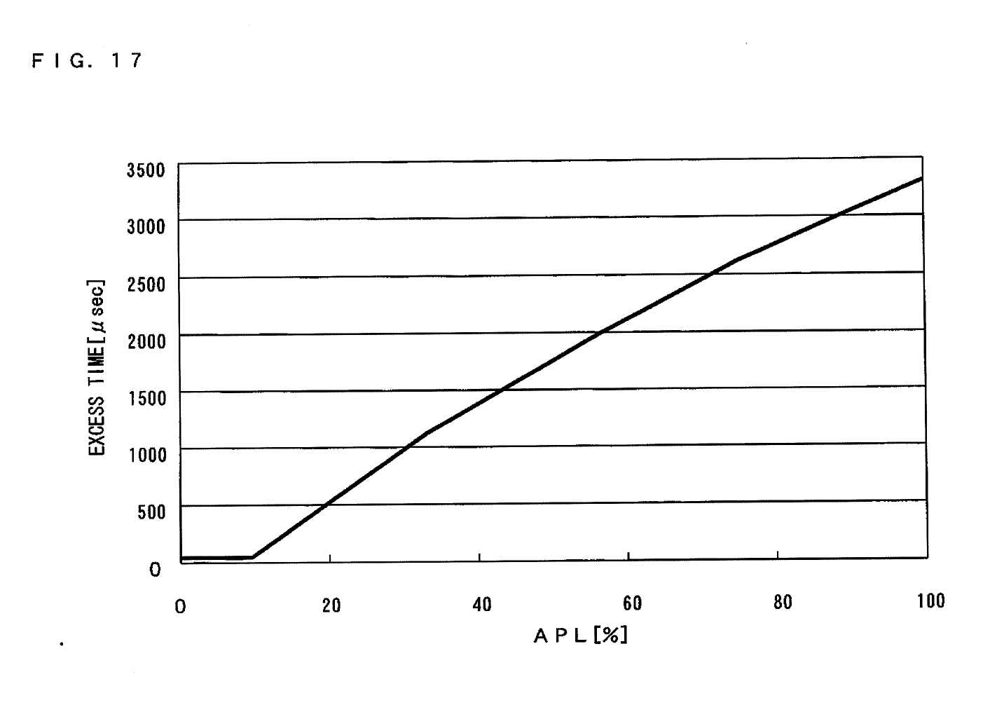

FIG. 17 is a diagram showing a relationship between the APL and an excess time when the scan electrodes SC1 to SCn are driven by the one-phase driving operation. Note that the excess time means a time period obtained by subtracting a minimum time period required for the setup period, the write period, the sustain period and so on from one field (16.67 msec).

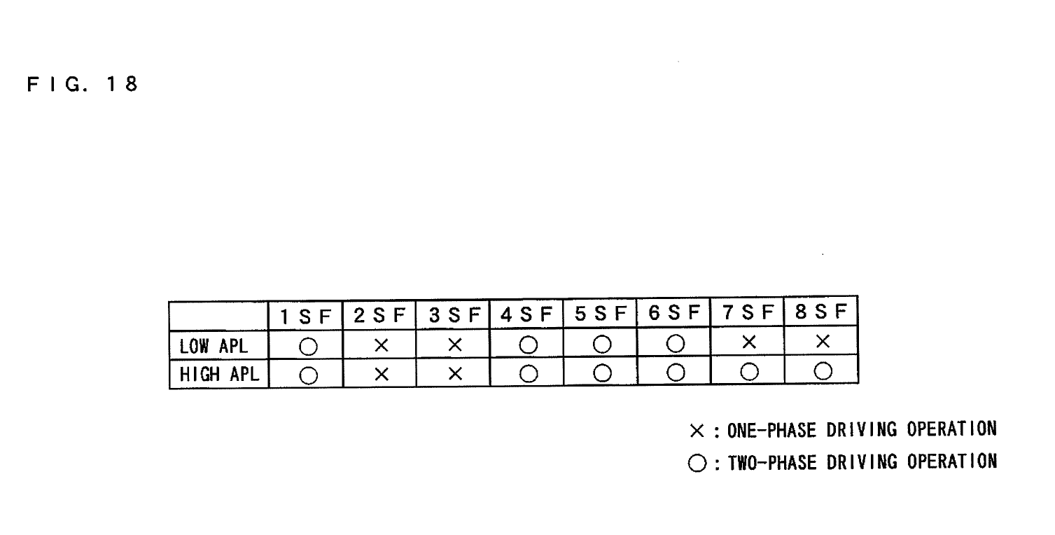

FIG. 18 is a diagram showing one example of a selection condition of the one-phase driving operation and the two-phase driving operation. In the example of FIG. 18, one field is composed of the first to eighth SFs. In FIG. 18, a low APL means an APL of not less than 5% and less than 30%, and a high APL means an APL of not less than 30% and not more than 100%, for example. In FIG. 18, “x” indicates that the scan electrodes SC1 to SCn are driven by the one-phase driving operation in the sub-field, and “∘” indicates that the scan electrodes SC1 to SCn are driven by the two-phase driving operation in the sub-field.

A sub-field in which the scan electrodes SC1 to SCn are driven by the one-phase driving operation is referred to as a one-phase SF, and a sub-field in which the scan electrodes SC1 to SCn are driven by the two-phase driving operation is referred to as a two-phase SF in the following description.

As shown in FIG. 17, the excess time hardly exists when the APL is about 0 to 10%, and the excess time increases with rising the APL when the APL is about 10% or more.

Here, the ramp waveform L6 or the ramp waveform L9 is applied to the scan electrodes SC1 to SCn in the two-phase SF as described referring to FIG. 5. Application of the ramp waveform L6 (L9) requires about 100 μs. Thus, the write period is lengthened in the case of application of the ramp waveform L6 or the ramp waveform L9. Therefore, the number of the sub-fields that are set as the two-phase SFs is preferably increased in the field in which the sufficient excess time can be ensured. Thus, the number of the two-phase SFs in one field is set larger as the APL becomes higher as shown in FIG. 18. This prevents time for applying the sustain pulses Ps from being insufficient even when the write period is lengthened because of the application of the ramp waveforms.

When the APL is high, a ratio of lighting discharge cells is high in many cases. When the ratio of lighting discharge cells is high, the wall charges in each discharge cell tend to be affected by the write pulses for generating the write discharges in other discharge cells. Thus, the wall charges of the second discharge cell group tend to decrease in a period where the write operation is performed in the first discharge cell group. Accordingly, the number of the two-phase SFs in one field is set larger as the APL becomes higher, so that discharge failures to be caused by the decrease of the wall charges in the second discharge cell group is prevented from occurring.

The wall charges of the second discharge cell group tend to decrease in a sub-field following a sub-field with the large number of sustain pulses. Therefore, the two-phase driving operation is performed in the first SF following the eighth SF with the large number of sustain pulses in the example of FIG. 18.

(1-9) Effects of the First Embodiment

As described above, the one-phase driving operation and the two-phase driving operation are selectively executed in the present embodiment.

In the two-phase driving operation, at the time of the setup discharges (the second weak discharges in the first SF) in the setup period, the potential of the first scan electrode group (the scan electrodes SC1, SC3, . . . , SCn−1) drops to (−Vad+Vset2) or (−Vad+Vset4), whereas the potential of the second scan electrode group (the scan electrodes SC2, SC4, . . . , SCn) drops to (−Vad+Vhiz). In this case, the amount of electric charges that transfer in the second discharge cell group due to the setup discharges is smaller than the amount of electric charges that transfer in the first discharge cell group. This allows the sufficient amount of electric charges to be stored in the second discharge cell group at the starting time point of the write period.

Thus, discharge failures to be caused by the decrease of the wall charges can be prevented from occurring in the second discharge cell group even though the wall charges stored in each discharge cell are decreased by the time when the scan pulse Pa is applied to each discharge cell of the second discharge cell group.

The weak discharges are generated in given discharge cells of the second discharge cell group after the application of the scan pulse Pa to the first discharge cell group is finished in the write period. Thus, each discharge cell of the second discharge cell group can be made suitable for the write operation immediately before the application of the scan pulse Pa to each discharge cell of the second discharge cell group. As a result, discharge failure to be caused by the decrease of the wall charges can be reliably prevented from occurring in each discharge cell of the second discharge cell group.

When excessive electric charges are stored in the second discharge cell group at the end of the setup period, the wall voltage in the second discharge cell group is maintained in a high state, and erroneous discharges tend to occur in the second discharge cell group in the write period. Specifically, when the write pulses for the write discharges are applied to the data electrodes D1, D2, . . . , Dm of the first discharge cell group, erroneous discharges occur in the second discharge cell group in the first half of the write period.

Therefore, the setup discharges are suitably generated in the second discharge cell group in the setup period in the present embodiment. This prevents the excessive electric charges from remaining in the second discharge cell group. Accordingly, the erroneous discharges are prevented from occurring in the second discharge cell group at the time of the write operation of the first discharge cell group.

The potential of the second scan electrode group is held at (−Vad+Vscn) in the write period in the present embodiment. This more reliably prevents the erroneous discharges from occurring in the second discharge cell group in the write period.

The sufficient amount of electric charges can remain in each discharge cell even though the potential (−Vad+Vscn) of the second scan electrode group is lowered to decrease the wall charges in each discharge cell of the second discharge cell group in the write period (excluding the period where the scan pulse Pa is applied). Since the potential of the second scan electrode group in the write period can be lowered, the voltage Vscn received by the power supply terminal V10 can be lowered.

As a result, the voltage Vscn can be efficiently lowered while the discharge cells can be reliably lit. This reduces cost for driving the panel 10 and improves the operation performance thereof.

The number of the two-phase SFs in one field is set larger as the value of the APL becomes higher in the present embodiment. Thus, discharge failures can be prevented from occurring in the discharge cells while the sufficient sustain period can be ensured.

In the present embodiment, a potential difference between the node N1 and the node N3 is held constant by the DC power supply 200. The scan electrodes SC1, SC3, . . . , SCn−1 are selectively connected to the node N1 or the node N2 through the scan ICs 100, and the scan electrodes SC2, SC4, . . . , SCn are selectively connected to the node N1 or the node N2 through the scan ICs 110. Thus, the common or different driving waveforms are applied to the scan electrodes SC1, SC3, . . . , SCn−1 and the scan electrodes SC2, SC4, . . . , SCn. In this manner, the common or different driving waveforms can be easily applied to the scan electrodes SC1, SC3, . . . , SCn−1 and the scan electrodes SC2, SC4, . . . , SCn without causing the configuration and operation of the scan electrode drive circuit 53 to be complicated. This reduces manufacturing cost of the scan electrode drive circuit 53.

### (2) Second Embodiment

Next, description is made of a plasma display apparatus according to a second embodiment of the present invention while referring to differences from the first embodiment.

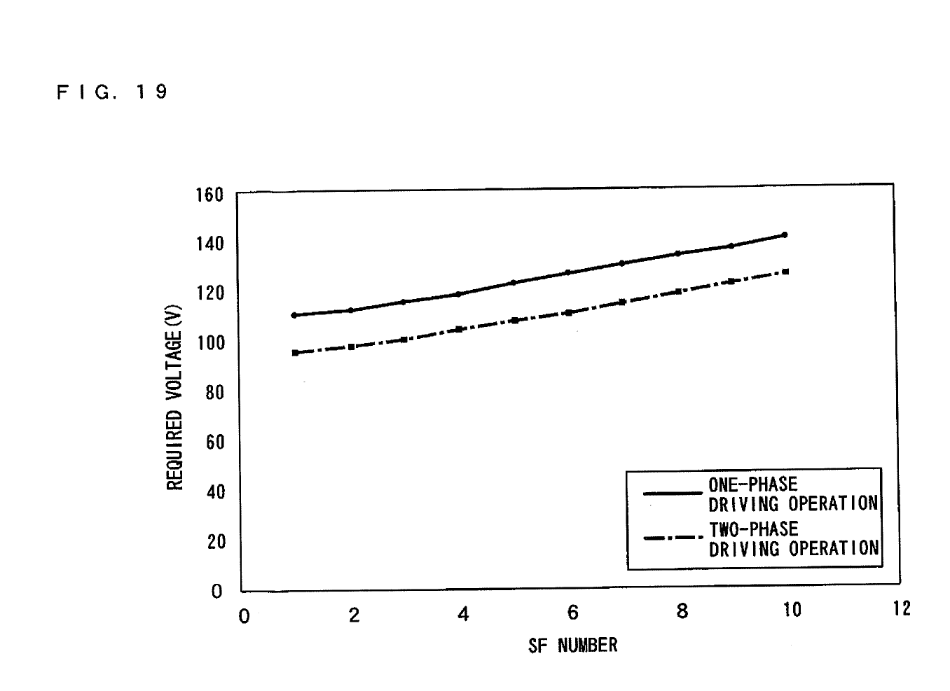

FIG. 19 is a diagram showing values of the voltage Vscn (hereinafter referred to as the required voltage) required for normal lighting of all the discharge cells (for generating the write discharges and the sustain discharges) in each sub-field. Note that the voltage Vscn (required voltage) is a voltage applied to the power supply terminal V10 of FIG. 7. In FIG. 19, the ordinate represents the required voltage, and the abscissa represents the sub-field number. Note that one field is composed of the first to tenth SFs, and the first to tenth SFs each have the luminance weights of 1, 2, 3, 6, 11, 18, 30, 44, 60 and 81 in the example of FIG. 19. The solid line indicates the required voltage when the scan electrodes SC1 to SCn are driven by the one-phase driving operation, and the one-dot and dash line indicates the required voltage when the scan electrodes SC1 to SCn are driven by the two-phase driving operation.

The required voltage for driving the scan electrodes SC1 to SCn by the two-phase driving operation is significantly lower than that for driving the scan electrodes SC1 to SCn by the one-phase driving operation as shown in FIG. 19. The required voltage is raised with increasing the luminance weight of the sub-field.

In the example of FIG. 19, the required voltage for normal lighting of the discharge cells by the two-phase driving operation (hereinafter referred to as the two-phase driving required voltage) in the tenth SF is higher than the required voltage for normal lighting of the discharge cells by the one-phase driving operation in the fifth SF. In this case, if the two-phase driving required voltage can be applied to the power supply terminal V10 (FIG. 7), the discharge cells can be normally lit by the one-phase driving operation in the first to fifth SFs.

Accordingly, when the discharge cells are lit by the one-phase driving operation in the first to fifth SFs and lit by the two-phase driving operation in the sixth to tenth SFs, the voltage Vscn applied to the power supply terminal V10 (FIG. 7) may not be set higher than the two-phase driving required voltage. Accordingly, the voltage Vscn can be significantly lowered as compared with the case where the discharge cells are lit by the one-phase driving operation in the first to tenth SFs.

In this manner, the discharge cells are lit by the one-phase driving operation in the sub-field in which the required voltage for normal lighting of the discharge cells by the one-phase driving operation is not more than the two-phase driving required voltage, and the discharge cells are lit by the two-phase driving operation in the other sub-fields in the second embodiment. This allows the voltage Vscn required for normal lighting of the discharge cells to be efficiently decreased.

### (3) Third Embodiment

(3-1) Configuration

Next, description is made of a plasma display apparatus according to a third embodiment of the present invention while referring to differences from the first embodiment.

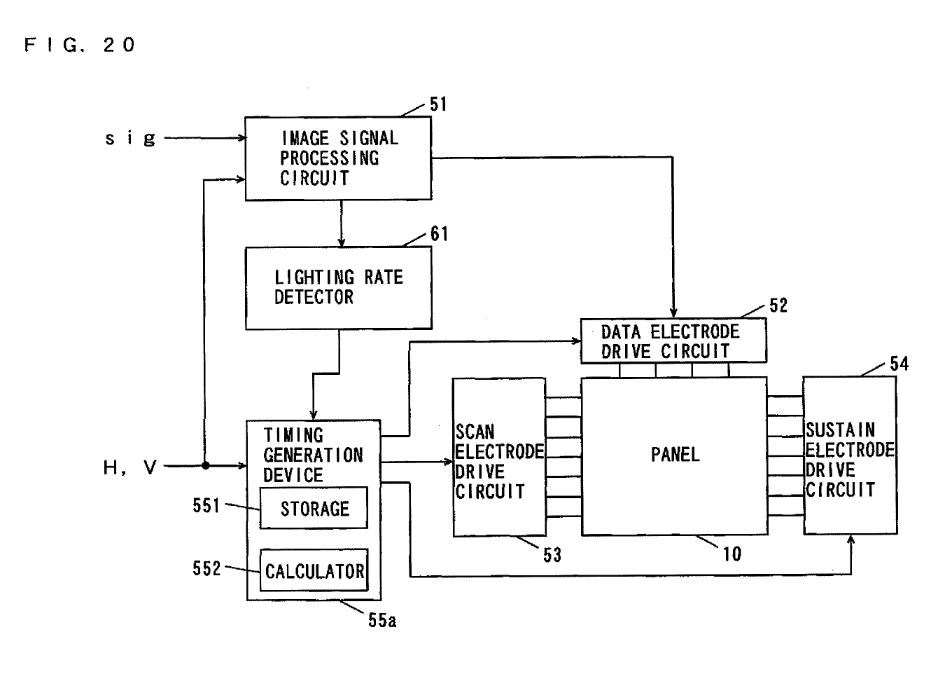

FIG. 20 is a block diagram of circuits in the plasma display apparatus according to the third embodiment. The plasma display apparatus includes a timing generation device 55a instead of the timing generation circuit 55 of FIG. 3, and includes a lighting rate detector 61 instead of the APL detector 56.

The image signal processing circuit 51 converts the image signal sig into the image data corresponding to the number of pixels of the panel 10, divides the image data on each pixel into the plurality of bits corresponding to the plurality of sub-fields, and outputs them to the data electrode drive circuit 52 and the lighting rate detector 61.

The timing generation device 55a generates a timing signal based on the horizontal synchronizing signal H, the vertical synchronizing signal V, a lighting rate detected by the lighting rate detector 61 and the luminance weight of each sub-field, and supplies the timing signal to each of the drive circuit blocks (the image signal processing circuit 51, the data electrode drive circuit 52, the scan electrode drive circuit 53 and the sustain electrode drive circuit 54).

The lighting rate detector 61 detects the lighting rate of discharge cells D simultaneously driven on the panel 10 from the image data for each sub-field output from the image signal processing circuit 51, and outputs the results to the timing generation device 55a.

Here, if the minimum unit of the discharge space that can be independently controlled to be put into a lighting/non-lighting state is referred to as a discharge cell, the lighting rate is given by the following equation:

Lighting rate (%)=(Number of the discharge cells that are simultaneously lit)/(Number of all discharge cells of the panel)×100. For example, when all the discharge cells D of the panel 10 are simultaneously lit, the lighting rate is 100%. When none of the discharge cells D is lit, the lighting rate is 0%.

The timing generation device 55a includes a storage 551 and a calculator 552. The storage 551 stores information representing a relationship among the required voltage, the lighting rate and the luminance weight, described below. The calculator 552 selects a given number of sub-fields of the plurality of sub-fields based on the horizontal synchronizing signal H, the vertical synchronizing signal V and the above-mentioned relationship stored in the storage 551.

The timing generation device 55a supplies the timing signal for the two-phase driving operation to the scan electrode drive circuit 53 in the sub-field selected by the calculator 552, and supplies the timing signal for the one-phase driving operation to the scan electrode drive circuit 53 in the sub-field that is not selected by the calculator 552. Accordingly, the scan electrodes SC1 to SCn are driven by the one-phase driving operation or the two-phase driving operation.

(3-2) Operation

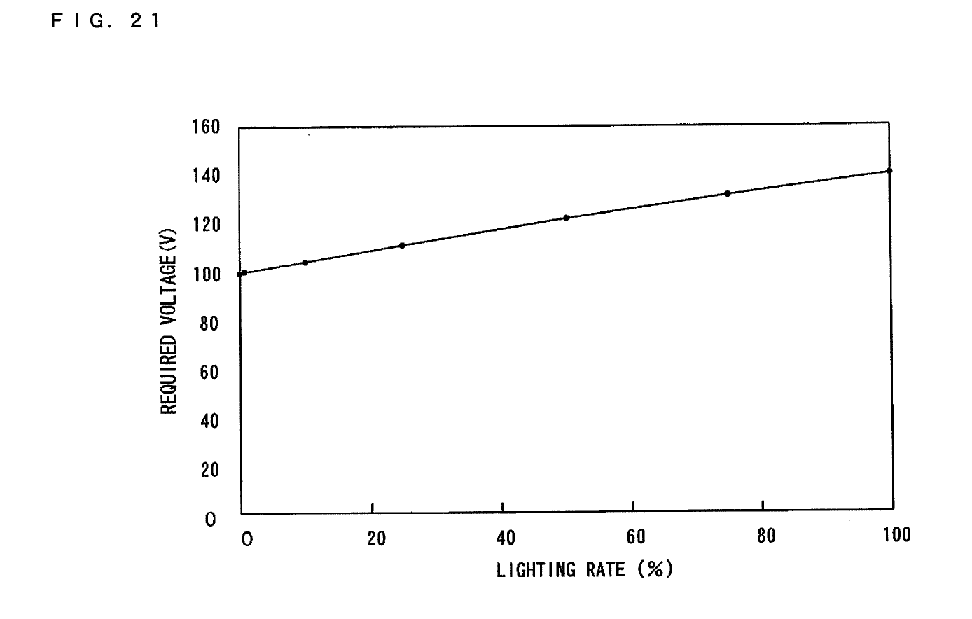

FIG. 21 is a diagram showing a relationship between the lighting rate and the required voltage when the scan electrodes SC1 to SCn are driven by the one-phase driving operation. In this example, one field is composed of the first to tenth SFs. FIG. 21 shows the relationship between the lighting rate and the required voltage in the tenth SF.

The required voltage of the sub-field changes according to the lighting rate as shown in FIG. 21. The required voltage of the sub-field changes according to the luminance weight as shown in FIG. 19.

In the present embodiment, the storage 551 of the timing generation circuit 55 of FIG. 20 previously stores the information representing the relationship among the luminance weight, the lighting rate and the required voltage. Then, the calculator 552 (FIG. 20) selects a given number of sub-fields in descending order of the required voltage in each field based on the relationship stored in the storage 551, and sets the selected sub-fields as the two-phase SFs. In the following example, the given number is set to five. Hereinafter, description is made of setting operation of the two-phase SFs by the calculator 552 while referring to the drawings.

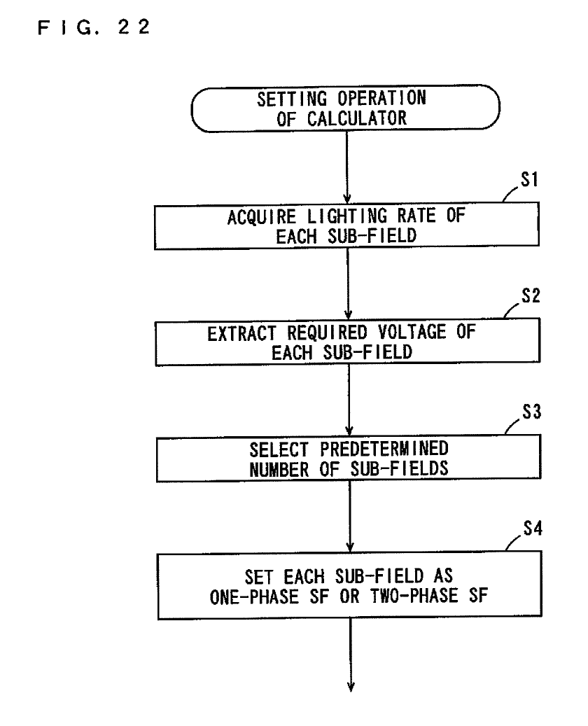

FIG. 22 is a flowchart showing the setting operation of sub-fields by the calculator 552.

As shown in FIG. 22, the calculator 552 first acquires the lighting rate of each sub-field of one field from the lighting rate detector 61 (FIG. 20) (Step S1). The calculator 552 then extracts the required voltage of each sub-field from the relationship among the lighting rate, the luminance weight and the required voltage stored in the storage 551 based on the acquired lighting rate of each sub-field (Step S2).

Next, the calculator 552 selects the given number (five in this example) of sub-fields having larger luminance weights of the first to tenth SFs based on the extracted required voltage of each sub-field (Step S3).

The calculator 552 subsequently sets the selected given number of sub-fields as the two-phase SFs, and sets the other sub-fields as the one-phase SFs (Step S4). In this manner, the selecting operation of the sub-fields by the calculator 552 is finished.

Next, description is made of setting of the one-phase SF and the two-phase SF by the operation described in FIG. 22 while taking the lighting rate of each sub-field as an example.

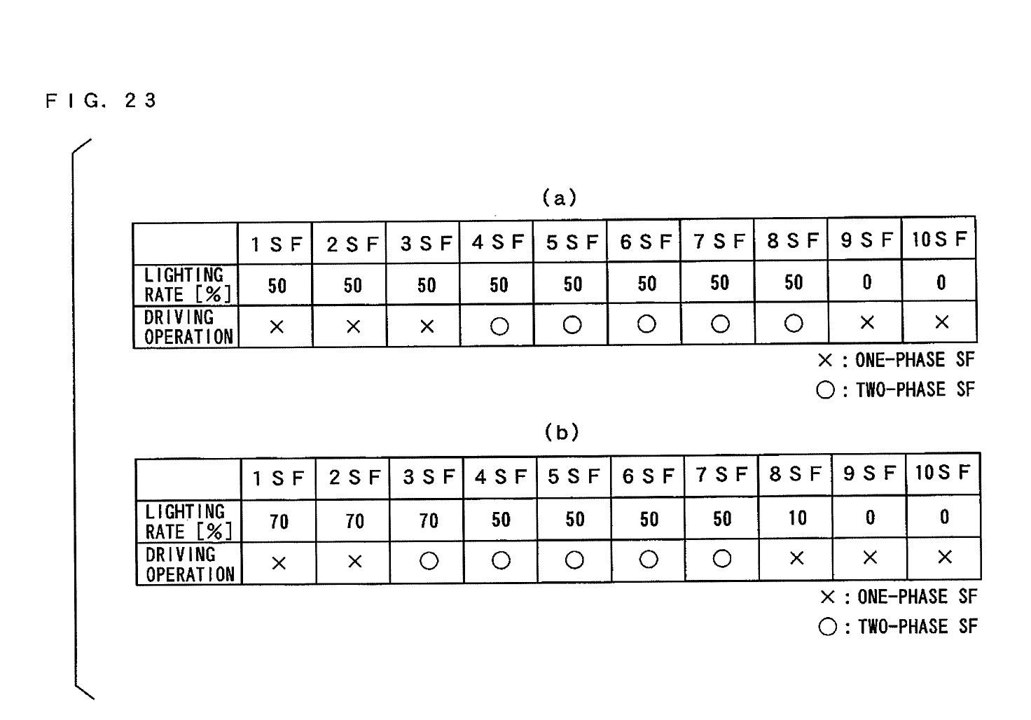

FIG. 23 is a diagram showing examples of setting of the one-phase SFs and the two-phase SFs. Note that in FIG. 23, “x” indicates that the sub-field is set as the one-phase SF, and “∘” indicates that the sub-field is set as the two-phase SF.

In the example of FIG. 23 (a), the lighting rate of each of the first to eighth SFs is 50%, and the lighting rate of each of the ninth SF and the tenth SF is 0%. In this case, since the required voltage in the sub-field having the lighting rate of 0% is low, the ninth SF and the tenth SF are set as the one-phase SFs. Since each of the first to eighth SFs has the lighting rate of 50%, the fourth to eighth SFs having the larger luminance weights are set as the two-phase SFs on a priority basis.

In the example of FIG. 23 (b), the lighting rate of each of the first to third SFs is 70%, the lighting rate of each of the fourth to seventh SFs is 50%, the lighting rate of the eighth SF is 10%, and the lighting rate of each of the ninth and tenth SFs is 0%. In this case, the ninth and tenth SFs having the lighting rates of 0% are set as the one-phase SFs, similarly to the example of FIG. 23 (a). In the example of FIG. 23 (b), the required voltage of the third SF having the lighting rate of 70% is higher than the required voltage of the eighth SF having the lighting rate of 10%. The required voltage of the fourth SF having the lighting rate of 50% is higher than the required voltage of the second SF having the lighting rate of 70%. Accordingly, the third to seventh sub-fields of the first to eighth SFs are set as the two-phase SFs.

In this manner, the given number of sub-fields are set as the two-phase SFs based on the lighting rate detected by the lighting rate detector 61 and the luminance weight of each sub-field in the third embodiment. This efficiently lowers the required voltage and prevents discharge failures from occurring in the discharge cells.

### (4) Fourth Embodiment

(4-1) Configuration

Next, description is made of a plasma display apparatus according to a fourth embodiment of the present invention while referring to differences from the first embodiment.

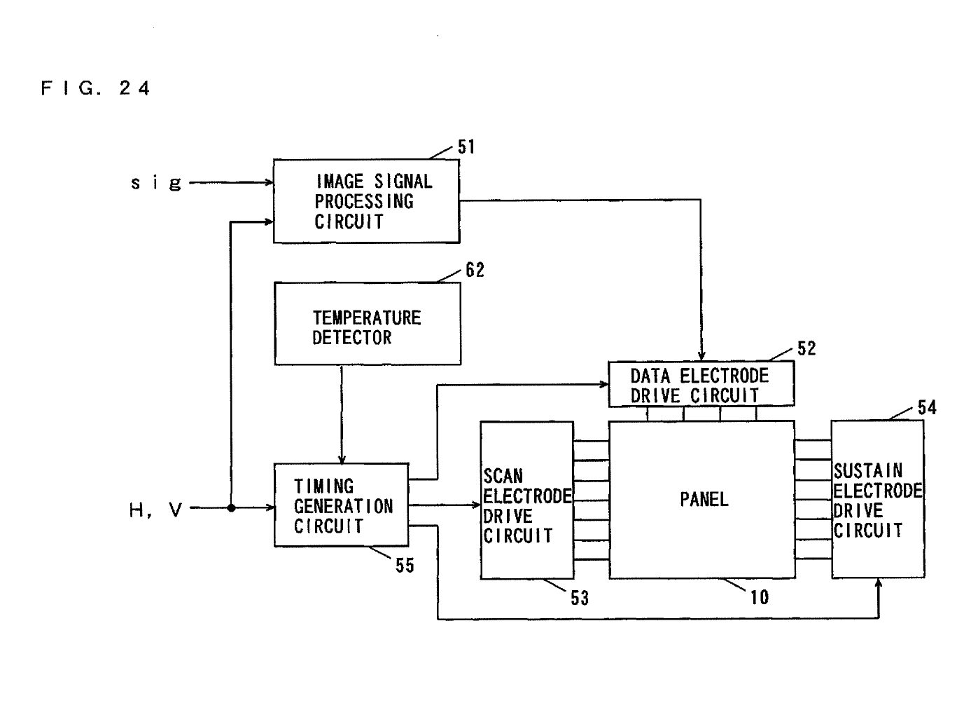

FIG. 24 is a block diagram of circuits in the plasma display apparatus according to the fourth embodiment of the present invention. The plasma display apparatus includes a temperature detector 62 instead of the APL detector 56 of FIG. 3.

The temperature detector 62 detects the temperature of the panel 10 by a temperature detecting element such as a thermocouple, not shown, and outputs a signal indicating the detected temperature to the timing generation circuit 55.

The timing generation circuit 55 selectively generates the timing signal for the one-phase driving operation and the timing signal for the two-phase driving operation based on the temperature detected by the temperature detector 62, and supplies the generated timing signals to the scan electrode drive circuit 53. This causes the scan electrodes SC1 to SCn to be driven by the one-phase driving operation or the two-phase driving operation.

(4-2) Operation

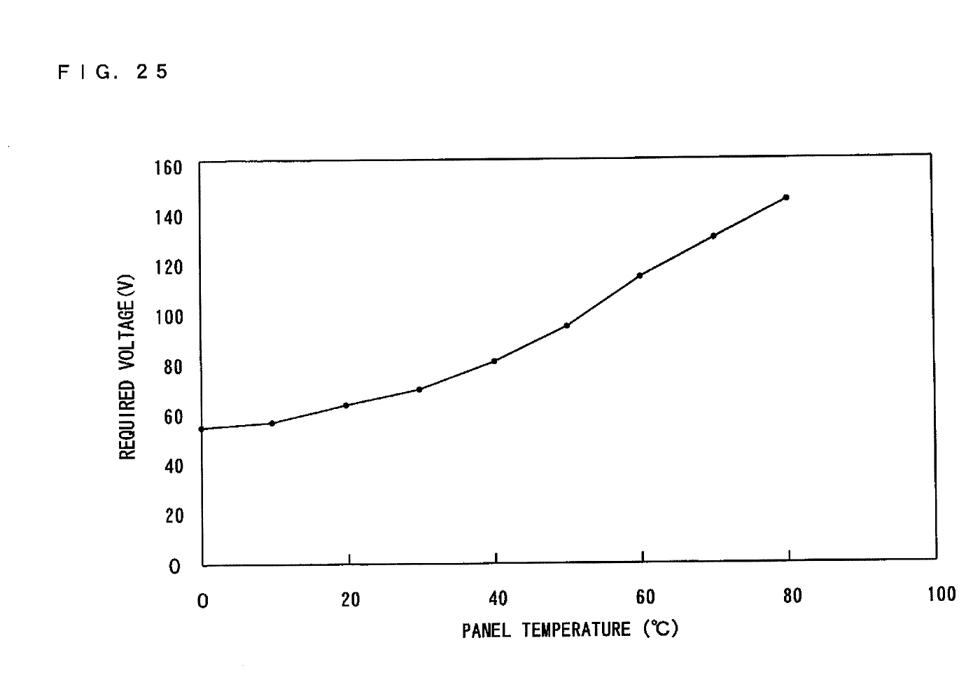

FIG. 25 is a diagram showing a relationship between the temperature of the panel 10 and the required voltage when the scan electrodes SC1 to SCn are driven by the one-phase driving operation in an arbitrary sub-field. Note that one field is composed of the first to tenth SFs in this example.

As shown in FIG. 25, the required voltage rises as the temperature of the panel 10 is increased. The required voltage for driving the scan electrodes SC1 to SCn by the two-phase driving operation is lower than that for driving the scan electrodes SC1 to SCn by the one-phase driving operation as shown in FIG. 19.

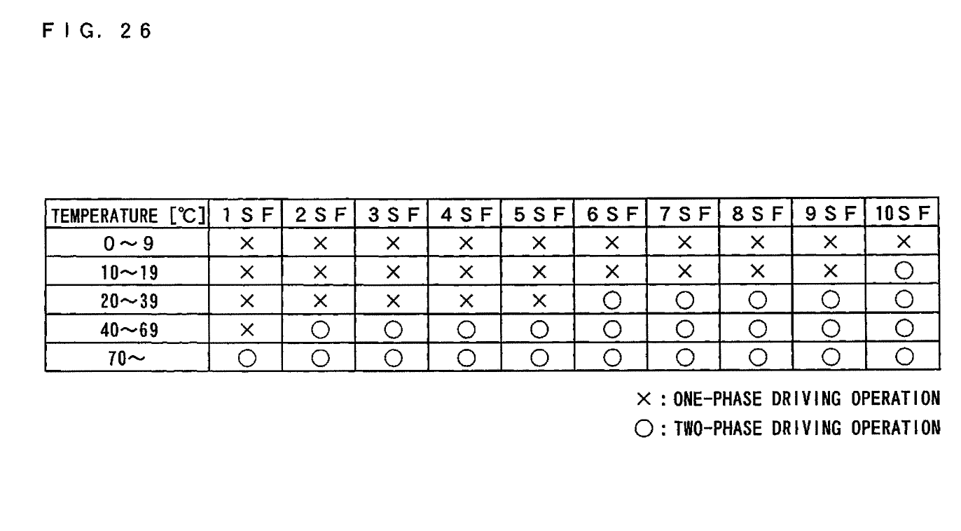

FIG. 26 is a diagram showing an example of a selection condition of the one-phase driving operation and the two-phase driving operation. Each value of the temperature (° C.) shown in FIG. 26 is obtained by rounding the first digit to the right of the decimal point. In FIG. 26, “x” indicates that the scan electrodes SC1 to SCn are driven by the one-phase driving operation in the sub-field, and “∘” indicates that the scan electrodes SC1 to SCn are driven by the two-phase driving operation in the sub-field.

The number of the sub-fields that are set as the two-phase SFs is set larger as the temperature of the panel 10 is increased as shown in FIG. 26 in the present embodiment. In this case, the required voltage can be sufficiently lowered when the temperature of the panel 10 is high, and the sustain period can be sufficiently ensured when the temperature of the panel 10 is low. Accordingly, discharge failures can be prevented from occurring in the discharge cells while the required voltage can be efficiently lowered.

As shown in FIG. 26, the sub-fields having larger luminance weights are set as the two-phase SFs on a priority basis. In this case, the required voltage can be further efficiently lowered.

As described above, the number of the two-phase SFs in one field is set larger as the temperature of the panel 10 is increased in the fourth embodiment. Accordingly, discharge failures can be prevented from occurring in the discharge cells while the required voltage can be efficiently lowered.

### (5) Other Embodiments

While the n-channel FET and the p-channel FET are used as the switching devices in the scan electrode drive circuit 53 in the foregoing embodiments, the switching devices are not limited to the foregoing examples.

For example, a p-channel FET, an IGBT (Insulated Gate Bipolar Transistor) or the like may be employed instead of the n-channel FET, and an n-channel FET, an IGBT (Insulated Gate Bipolar Transistor) or the like may be employed instead of the p-channel FET in each of the above-described circuits.

While the setup operation for all cells is performed in the first SF in the foregoing embodiments, the selective setup operation may be performed in the first SF and the setup operation for all cells may be performed in any SF of the second SF and the subsequent SFs.

While the scan electrodes SC1, SC3, . . . , SCn−1 are referred to as the first scan electrode group and the scan electrodes SC2, SC4, . . . , SCn are referred to as the second scan electrode group in the foregoing embodiments, the scan electrodes SC1 to SCn/2 may be referred to as the first scan electrode group, and the scan electrodes SCn/2+1 to SCn may be referred to as the first scan electrode group. In this case, the sustain electrodes SU1 to SUn/2 are referred to as the first sustain electrode group, and the sustain electrodes SUn/2+1 to SUn are referred to as the second sustain electrode group.

While the scan electrodes SC1 to SCn are divided into the first and second scan electrode groups and all the discharge cells of the panel 10 are divided into the first and second discharge cell groups in the foregoing embodiments, the scan electrodes SC1 to SCn may be divided into three or more scan electrode groups and all the discharge cells of the panel 10 may be divided into three or more discharge cell groups.

In the case, the two-phase driving operation can be performed in at least two scan electrode groups of three or more scan electrode groups similarly to the foregoing embodiments.

While the ramp waveforms L6, L9 (FIG. 5) are applied to the first scan electrode group (the scan electrodes SC1, SC3, . . . , SCn−1) in the foregoing embodiments, the ramp waveforms L6, L9 may not be applied to the first scan electrode group.

While the first and second scan electrode groups drop from the ground potential to (−Vad+Vset2 (Vset3 or Vset4)) at a constant rate of change in the write period in the two-phase driving operation in the foregoing embodiments, the present invention is not limited to this. For example, the potentials of the first and second scan electrode groups may instantaneously drop to (−Vad+Vhiz), and then may gradually drop from (−Vad+Vhiz) to (−Vad+Vset2 (Vset3 or Vset4)).

While the tenth SF has the largest luminance weight in the second to fourth embodiments, another SF may have the largest luminance weight.

### (6) Correspondences between Elements in the Claims and Parts in Embodiments

In the following paragraphs, non-limiting examples of correspondences between various elements recited in the claims below and those described above with respect to various preferred embodiments of the present invention are explained.

In the foregoing embodiments, the scan electrodes SC1, SC3, . . . , SCn−1 are examples of a plurality of first scan electrodes, and the scan electrodes SC2, SC4, SCn are examples of a plurality of second scan electrodes.

The first drive circuit DR1 is an example of a first circuit, the second drive circuit DR2 is an example of a second circuit, the potential Vsus or the ground potential is an example of a first potential, (−Vad+Vset2) or (−Vad+Vset4) is an example of a second potential, (−Vad+Vhiz) is an example of a third potential, (−Vad+Vhiz+Vscn) is an example of a fourth potential, (−Vad+Vscn) is an example of a fifth potential, the ground potential is an example of a sixth potential, and (−Vad+Vset2) or (−Vad+Vset3) is an example of a seventh potential.

The ramp waveform L2 or the ramp waveform L4 is an example of a first ramp waveform, the ramp waveform L5 or the ramp waveform L8 is an example of a second ramp waveform, the ramp waveform L6 or the ramp waveform L9 is an example of a third ramp waveform, and a portion of the scan electrode drive circuit 53 excluding the first and second drive circuits DR1, DR2, the DC power supply 200, the recovery circuit 300 are examples of a potential control circuit, the DC power supply 200 is an example of a hold circuit, the node N1 is an example of a given node, the scan IC 100 is an example of a first switch circuit, the scan IC 110 is an example of a second switch circuit, the APL detector 56 is an example of a luminance level detector, the lighting rate detector 61 is an example of a lighting rate detector, the calculator 552 is an example of a selector, and the temperature detector 62 is an example of a temperature detector.

As each of various elements recited in the claims, various other elements having configurations or functions described in the claims can be also used.

### INDUSTRIAL APPLICABILITY

The present invention is applicable to a display apparatus that displays various images.

1. A driving device of a plasma display panel that drives the plasma display panel including discharge cells at intersections of a plurality of first and second scan electrodes and a plurality of sustain electrodes with a plurality of data electrodes by a sub-field method in which one field period includes a plurality of sub-fields, comprising:
a first circuit that drives said plurality of first scan electrodes; and
a second circuit that drives said plurality of second scan electrodes, wherein
said first and second circuits perform a two-phase driving operation in at least one sub-field of said plurality of sub-fields,
said first circuit applies a first ramp waveform that drops from a first potential to a second potential to said plurality of first scan electrodes in a setup period, and sequentially applies a scan pulse to said plurality of first scan electrodes in a write period in said two-phase driving operation, and
said second circuit applies a second ramp waveform that drops from said first potential to a third potential that is higher than said second potential to said plurality of second scan electrodes and raises a potential of said plurality of second scan electrodes to a fourth potential after said second ramp waveform is applied in said setup period, and holds said plurality of second scan electrodes at a fifth potential that is higher than said third potential and lower than said fourth potential and sequentially applies a scan pulse to said plurality of second scan electrodes after the scan pulse is applied to said plurality of first scan electrodes in said write period in said two-phase driving operation.

2. The driving device of the plasma display panel according to claim 1, wherein said second circuit applies a third ramp waveform that drops to said plurality of second scan electrodes after the scan pulse is applied to said plurality of first scan electrodes and before the scan pulse is applied to said plurality of second scan electrodes in said write period in said two-phase driving operation.

3. The driving device of the plasma display panel according to claim 2, wherein said second circuit applies the third ramp waveform that drops from a sixth potential that is not higher than said fifth potential to a seventh potential to said plurality of second scan electrodes after the scan pulse is applied to said plurality of first scan electrodes and before the scan pulse is applied to said plurality of second scan electrodes in said write period in said two-phase driving operation.

4. The driving device of the plasma display panel according to claim 2, wherein said seventh potential is lower than said second potential.

5. The driving device of the plasma display panel according to claim 1, further comprising
a potential control circuit that changes a potential of a first node, and
a hold circuit that holds a potential difference between said first node and a second node at a given potential difference, wherein
a difference between said third potential and said fourth potential is said given potential difference,
said first circuit includes a plurality of first switch circuits, each of which switches a connection state between each of said plurality of first scan electrodes and said first node,
said second circuit includes a plurality of second switch circuits, each of which switches a connection state between each of said plurality of second scan electrodes and said first node,
said potential control circuit drops the potential of said first node from said first potential to said second potential in the setup period of said at least one sub-field,
said plurality of first switch circuits connect said plurality of first scan electrodes to said first node, respectively, in a period where the potential of said first node changes from said first potential to said second potential in the setup period of said at least one sub-field, and
said plurality of second switch circuits connect said plurality of second scan electrodes to said first node, respectively, in a period where the potential of said first node changes from said first potential to said third potential, and connect said plurality of second scan electrodes to said second node, respectively, in a period where the potential of said first node changes from said third potential to said second potential in the setup period of said at least one sub-field.

6. The driving device of the plasma display panel according to claim 1, wherein
said plasma display panel is driven based on an image signal,
said driving device of the plasma display panel further includes a luminance level detector that detects an average luminance level of an image in one flame displayed on said plasma display panel based on said image signal, and
said first and second circuits perform said two-phase driving operation in sub-fields, whose number increases, of said plurality of sub-fields as the average luminance level detected by said luminance level detector becomes higher.

7. The driving device of the plasma display panel according to claim 1, wherein
said plurality of sub-fields have respective luminance weights, and
said first and second circuits perform said two-phase driving operation in a sub-field having a luminance weight of not less than a predetermined luminance weight of said plurality of sub-fields.

8. The driving device of the plasma display panel according to claim 1, wherein
said plasma display panel is driven based on an image signal,
said driving device of the plasma display panel further includes
a lighting rate detector that detects a lighting rate of said plasma display panel based on said image signal, and
a selector that selects at least one sub-field of said plurality of sub-fields based on the lighting rate detected by said lighting rate detector, and
said first and second circuits perform said two-phase driving operation in the sub-field selected by said selector.

9. The driving device of the plasma display panel according to claim 1, further comprising a temperature detector that detects a temperature of said plasma display panel, wherein
said first and second circuits perform the two-phase driving operation in sub-fields, whose number increases, of said plurality of sub-fields as the temperature detected by said temperature detector becomes higher.

10. A driving device of a plasma display panel that drives the plasma display panel including discharge cells at intersections of a plurality of scan electrodes and a plurality of sustain electrodes with a plurality of data electrodes by a sub-field method in which one field period includes a plurality of sub-fields, wherein
said plurality of scan electrodes are categorized into a plurality of scan electrode groups including at least first and second scan electrode groups,
said driving device of the plasma display panel includes
a first circuit that drives said first scan electrode group, and
a second circuit that drives said second scan electrode group,
said first and second circuits perform a two-phase driving operation in at least one sub-field of said plurality of sub-fields,
said first circuit applies a first ramp waveform that drops from a first potential to a second potential to said first scan electrode group in a setup period, and sequentially applies a scan pulse to said first scan electrode group in a write period in said two-phase driving operation, and
said second circuit applies a second ramp waveform that drops from said first potential to a third potential that is higher than said second potential to said second scan electrode group and raises a potential of said second scan electrode group to a fourth potential after said second ramp waveform is applied in said setup period, and holds said second scan electrode group at a fifth potential that is higher than said third potential and lower than said fourth potential and sequentially applies a scan pulse to said second scan electrode group after the scan pulse is applied to said first scan electrode group in said write period in said two-phase driving operation.

11. A driving method of a plasma display panel that drives the plasma display panel including discharge cells at intersections of a plurality of first and second scan electrodes and a plurality of sustain electrodes with a plurality of data electrodes by a sub-field method in which one field period includes a plurality of sub-fields, comprising the steps of:
applying a first ramp waveform that drops from a first potential to a second potential to said plurality of first scan electrodes in a setup period, and sequentially applying a scan pulse to said plurality of first scan electrodes in a write period in at least one sub-field of said plurality of sub-fields; and
applying a second ramp waveform that drops from said first potential to a third potential that is higher than said second potential to said plurality of second scan electrodes and raises a potential of said plurality of second scan electrodes to a fourth potential after said second ramp waveform is applied in said setup period, and holding said plurality of second scan electrodes at a fifth potential that is higher than said third potential and lower than said fourth potential and sequentially applying a scan pulse to said plurality of second scan electrodes after the scan pulse is applied to said plurality of first scan electrodes in said write period in said at least one sub-field.

12. A plasma display apparatus comprising:
a plasma display panel that includes discharge cells at intersections of a plurality of first and second scan electrodes and a plurality of sustain electrodes with a plurality of data electrodes; and
a driving device that drives said plasma display panel by a sub-field method in which one field period includes a plurality of sub-fields, wherein
said driving device includes
a first circuit that drives said plurality of first scan electrodes, and
a second circuit that drives said plurality of second scan electrodes,
said first and second circuits perform a two-phase driving operation in at least one sub-field of said plurality of sub-fields,
said first circuit applies a first ramp waveform that drops from a first potential to a second potential to said plurality of first scan electrodes in a setup period, and sequentially applies a scan pulse to said plurality of first scan electrodes in a write period in said two-phase driving operation, and
said second circuit applies a second ramp waveform that drops from said first potential to a third potential that is higher than said second potential to said plurality of second scan electrodes and raises a potential of said plurality of second scan electrodes to a fourth potential after said second ramp waveform is applied in said setup period, and holds said plurality of second scan electrodes at a fifth potential that is higher than said third potential and lower than said fourth potential and sequentially applies a scan pulse to said plurality of second scan electrodes after the scan pulse is applied to said plurality of first scan electrodes in said write period in said two-phase driving operation.
